(19) United States
(12) Patent Application Publication
(10) Pub. No.: US 2017/0270318 A1
(43) Pub. Date: Sep. 21, 2017

(54) PRIVACY IMPACT ASSESSMENT SYSTEM AND ASSOCIATED METHODS

(71) Applicant: Stuart Ritchie, Hertfordshire (GB)

(72) Inventor: Stuart Ritchie, Hertfordshire (GB)

(21) Appl. No.: 15/459,909

(22) Filed: Mar. 15, 2017

Related U.S. Application Data
(60) Provisional application No. 62/308,310, filed on Mar. 15, 2016.

(51) Int. Cl. G06F 21/62; G06F 21/60

(52) U.S. Cl. CPC G06F 21/6263; G06F 21/604; G06F 2221/2141

(57) ABSTRACT

A privacy impact assessment system implements a method for data privacy compliance code generation. The system creates a legal architecture from legal guidance and a legal metadata test associated with a jurisdiction of interest. The system creates a privacy architecture from privacy guidance and a privacy metadata test (either process-level or transaction-level). Upon receipt of a data flow identifier, the system retrieves an associated privacy metadata test from the privacy architecture. If a relevant jurisdiction from the privacy metadata test matches the jurisdiction of interest of the legal metadata test, the system retrieves the legal metadata test associated with the jurisdiction of interest from the legal architecture. The system uses the privacy metadata test and the legal metadata test to determine an outstanding risk to privacy information used by a data flow present in the privacy metadata test, and to create a privacy impact assessment report highlighting the outstanding risk.

### RELATED APPLICATIONS

This application claims the benefit under 35 U.S.C §119(e) of U.S. Provisional Patent Application Ser. No. 62/308,310 filed by the inventor of the present application on Mar. 15, 2016, and titled Privacy impact Assessment System and Associated Methods, the entire content of which is incorporated herein by reference.

### FIELD OF INVENTION

The present invention relates to the field of privacy data protection and, more specifically, to computer-implemented systems and methods for facilitating privacy rules compliance and trusted transaction processing in multi-platform computing environments and multi-jurisdictional legal environments.

### BACKGROUND OF THE INVENTION

Although the Constitution of the United States contains no express right to privacy, several decades of cases heard by the Supreme Court of the United States cement individual privacy as a right. By contrast, in the European Union (EU), privacy is recognized as a human right by all signatories to the European Convention of Human Rights (Article 8), and as quasi-constitutional rights in the European Charter of Fundamental Rights (Articles 7, 8) incorporated into the 2009 Treaty of the European Union. As the amount of information transmitted over networks by businesses, individuals, and other entities continues to grow, the ability of responsible parties to safeguard the internationally-recognized right to privacy of personal information has become an ongoing challenge. For example, users who subscribe to a given provider's services are often required to disclose sensitive personal information, such as credit card information, medical information, and family information. Allowing such information to pass beyond the control of its owners introduces inherent exposure risks. Furthermore, the risk of exposing such personal data to breach and/or misuse increases, for example, in a business-to-business (B2B) or enterprise-to-enterprise (E2E) environment, within either of which such personal data of an end user may be transmitted between two or more businesses or entities during a transaction in which the end-user is not a direct party.

Toward the end of empowering citizens with control over their personal data, while at the same time facilitating a business-conducive regulatory environment, the United States, European Union, and various other jurisdictions around the world have instituted statutory reforms in the field of privacy data protection. Many regulatory bodies worldwide subscribe to the concept of “Privacy by Design (PbD),” which was developed in the 1990s by Ontario Information and Privacy Commissioner, Dr. Ann Cavoukian, as guidance for technology companies that gather personal information. Fundamental to Privacy by Design is the notion that those who are designing technology ought to consider privacy as part and parcel of their automation designs.

PbD, which has gained widespread international recognition as a global privacy standard, is based on the following 7 Foundational Principles:

1. Proactive not Reactive—Preventative not Remedial: The cornerstone of the first principle is that automation designers, should think about data privacy at the beginning of the data protection planning process, and not only after a data breach.

2. Privacy as the Default Setting: Automation designers are to give consumers the maximum privacy protection as a baseline (for example, explicit opt-in, safeguards to protect consumer data, restricted sharing, minimized data collection, and retention policies in place). Privacy by Default, therefore, directly lowers the data security risk profile: the less data a service provider has, the less damage may be done as a result of a breach.

3. Privacy Embedded into Design: Privacy safeguards are to be embedded into the design of information technology (IT) systems and business practices, including data security techniques such as encryption and authentication. Testing should be accomplished at least for the most common hackable vulnerabilities in software (typically injection attacks). Simply put, automation designers should treat privacy as a core feature of the product.

4. Full Functionality—Positive-Sum, Not Zero-Sum: Rather than compromise business goals, PbD can instead promote privacy, revenue, and growth without sacrificing one for the other. Automation designers must establish a PbD culture in their development organizations.

5. End-to-End Security—Full Lifecycle Protection: Privacy protections should follow the data, wherever it goes. The same PbD principles apply when the data is first created, shared with others, and then finally archived. Appropriate encryption and authentication should protect the data until it no longer exists in the computing environment (e.g., finally deleted).

6. Visibility and Transparency—Keep it Open: To help build trust with consumers, information about a development organization's privacy practices should be out in the open and written in non-legalese. A clear redress mechanism for consumers should be publicly available, and lines of responsibility in the development organization need to be established.

7. Respect for User Privacy—Keep it User-Centric: Simply put, consumers own their data. Data held by the handling organization must be accurate, and the consumer must be given the power to make corrections. The consumer is also the only one who can grant and revoke consent on the use of the data.

8. Complementary to at least PbD Principle 2, another data protection concept. “Privacy by Default,” is expressed in Article 23 of the EU General Data Protection Regulation (GDPR), as agreed in December 2015, as the expectation that “the (data) controller shall implement mechanisms for ensuring that, by default, only those personal data are processed which are necessary for each specific purpose of the processing and are especially not collected or retained beyond the minimum necessary for those purposes, both in terms of the amount of the data and the time of their storage. In particular, those mechanisms shall ensure that by default personal data are not made accessible to an indefinite number of individuals.” Taken collectively, the principles described above represent the conceptual evolution of privacy since they explicate the inclusion of privacy into the design of the business processes and IT applications support, in order to include all the necessary security requirements at the initial implementation stages of such developments (Privacy by Design), as well as to put in place mechanisms to ensure that only personal information needed for each specific purpose are processed “by default” (Privacy by Default).

Predictably, Keeping up with emerging privacy law/jurisdiction-specific regulations and also applying best practices in Privacy by Design and Privacy by Default pose a heavy burden to an enterprise tasked with building, maintaining, and/or using an automated system that requires manipulation, storage, and/or protection of privacy information. Non-compliance with legally-mandated regulations may cause an enterprise to incur heavy financial burdens such as fines, loss of business revenue, loss of business opportunity, and/or civil lawsuits. Accordingly, large investments of time, money, and manpower may be expended to develop programs, processes, and infrastructure within the business enterprise to ensure current and ongoing compliance with regulations and best practices. Verifiable compliance with regulations is made even more challenging because regulations may change over time. Regulatory changes may be incremental and gradual, and at times may be significant. A typical business enterprise may have several thousands of policies, procedures, test plans, and monitoring controls throughout the enterprise to monitor compliance and to respond to potential and actual occurrences of non-compliance. The additional effort of assessing changes when new or updated regulations are published, and then having to update the enterprise's compliance policies and procedures in response, may impose a heavy burden to the enterprise.

Because privacy laws and regulations are constantly changing, and automated systems (by virtue of ongoing software maintenance and functionality improvements) are also changing, proactivity in identifying and mitigating risks to privacy information (as expected under Privacy by Design and Privacy by Default) remains a challenge in the industry. Privacy Impact Assessment (PIA) automation may be useful in assessing such risk, prioritizing identified risks for preventive action, and reporting risk posture to regulators and internal auditors. However, known PIA implementations fail to keep up to emerging privacy law, which changes much faster than IT technology.

Further complicating the privacy data protection challenge, promulgation of both emerging privacy laws and privacy information handling best practices has created the need for competent Data Protection Officers whose statutory skills requirements include knowledge (to expert level) of international privacy law, conflicts of law among jurisdictions, data security mechanisms and procedures, and the provision of de facto mediation services between individuals and the enterprise. As these are radically different fields, and such multi-disciplinary training is not offered as part of commonly-available academic or private courses of study, finding and engaging such persons of wide-ranging skills often proves to be prohibitively difficult. “Organizations today need to have both lawyers and engineers involved in privacy compliance efforts.” (Dennedy, Fox, and Finneran, The Privacy Engineer's Manifesto: Getting from Pokey to Code to QA to Value, 2014, p90). Unfortunately, known privacy PIA implementations fail to help bridge the knowledge gap between these disparate fields of expertise that are nonetheless critical to privacy impact assessment success.

For example, TRUSTe® provides a series of workflow recordkeeping templates against which an enterprise's policies and practices may be assessed to give a dashboard analysis of where the enterprise stands with regard to globally-recognized privacy frameworks, including Fair Information Practice Principles (FIPPs), Organization of Economic Co-Operation and Development (OECD) privacy principles. Generally Accepted Privacy Principles (GAPP), and state and local frameworks such as California Online Privacy Protection Act (CalOPPA) privacy policy requirements. However, template-based solutions such as TRUSTe®, at best, require manual assessment processes. Such solutions require pre-selection of a (potentially limited) list of laws and jurisdictions to be covered, which presumes a preliminary expert assessment of where the enterprise might be vulnerable to risk of breach.

The following are examples of other implementations in the privacy information space:

U.S. patent application Ser. No. 13/546,145 by Zeng

U.S. Pat. No. 8,986,575 to McQuay et al.

U.S. Pat. No. 8,893,289 to Fredinburg et al.

U.S. patent application Ser. No. 14/202,477 by Jacquin

PCT/EP2012/062500 by Gouget et al.

Thus, an industry need exists to provide methods, systems, and architectures that will substitute for or assist industry to develop such capabilities as those described above. More specifically, there exists a need in the industry for a solution capable of automatically performing PIA and analysis, white keeping up with ever-changing privacy laws and regulations. Also needed is a solution capable of performing financial quantification of identified risks to policy information. Also needed is a solution capable of facilitating proactive embedding of privacy-by-design (PbD) and/or privacy-by-default into IT processes. Also needed is a solution capable of preparing notification lists, breach assessments, and/or privacy policy schedules to guide risk mitigation efforts and to ensure timely response to inquiries by regulators and auditors.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to methods and associated software-based systems that structure and perform, inter alia (a) on-demand privacy risk assessments on automated processes involving privacy data, and (b) transaction-level Privacy by Design analyses on target data flows; both while dynamically self-adjusting to changing privacy law in applicable jurisdictions.

More specifically, the present invention comprises a system and associated computer-implemented methods for encapsulating data privacy law and performing automated quantified financial risk assessments against proposed or actual data processes involving privacy data, and for injecting statutory and/or informal Privacy by Design concepts directly into planned or legacy IT systems at the level of source code. The invention includes integrating privacy governance (e.g., legal/compliance) and privacy engineering (information technology) for any enterprise into a relatively “hard” template with complementary software support to advantageously simplify, structure, facilitate, and automate a collaborative law/compliance/IT multidisciplinary approach to Privacy-By-Design (PbD) engineering, putting multi-jurisdictional privacy impact/risk assessments at the heart of the architecture.

The present invention may comprise legal and privacy architectures with associated software that may define a common language shared by users, stockholders, IT developers, compliance professionals, lawyers, regulators, internal auditors, external auditors, litigators, witnesses, courts, actuaries, insurance underwriters, and other interested parties. For example, prospective consumers of a particular work flow may be empowered by the present invention to advantageously evaluate privacy risk for themselves using the published privacy risk assessments of other users.

In one embodiment of the invention, a computer-implemented method for data privacy compliance code generation may employ a privacy impact assessment system. The system may receive legal guidance and also a legal metadata test associated with a jurisdiction of interest, and may use both to create a legal architecture. The system similarly may receive privacy guidance and also a privacy metadata test (either process-level or transaction-level). The system may create a privacy architecture comprising the privacy guidance and the privacy metadata test.

The system may receive a data flow identifier associated with the privacy metadata test, and may use that data flow identifier to retrieve an associated privacy metadata test from the privacy architecture, if the system detects a match between a relevant jurisdiction from the privacy metadata test and the jurisdiction of interest of the legal metadata test, the system may retrieve the legal metadata test associated with the jurisdiction of interest from the legal architecture. The system may use the privacy metadata test and the legal metadata test to determine an outstanding risk to privacy information used by a data flow present in the privacy metadata test, and may create a privacy impact assessment report highlighting the outstanding risk.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a schematic block diagram of a privacy impact assessment system (PIAS) according to an embodiment of the present invention.

FIG. 2 is an illustration of exemplary data structures for the privacy impact assessment system depicted in FIG. 1.

FIG. 3 is a diagram illustrating classifications of users of a privacy impact assessment system according to an embodiment of the present invention.

FIG. 4 is a flow chart detailing a method of legal architecture creation and editing as used in connection with a privacy impact assessment system according to an embodiment of the present invention.

FIG. 5 is a flow chart detailing a method of privacy architecture creation and editing as used in connection with a privacy impact, assessment system according to an embodiment of the present invention.

FIG. 6 is a flow chart detailing a method of privacy impact analysis and report generation as used in connection with a privacy impact assessment system according to an embodiment of the present invention.

FIG. 7 is a flow chart a method of application programming interface (API) packaging and deployment as used in connection with a privacy impact assessment system according to an embodiment of the present invention.

FIG. 8 is a block diagram representation of a machine in the example form of a computer system according to an embodiment of the present invention.

FIG. 9 is a flow chart of a method of user interaction with a privacy impact assessment system according to an embodiment of the present invention.

FIG. 10 is a diagram illustrating an exemplary risk assessment report generated by a privacy impact assessment system according to an embodiment of the present invention.

FIG. 11 is a diagram illustrating an exemplary privacy architecture created by a privacy impact assessment system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

In the interest of clarity, not all of the routine features of the implementations described herein are shown and described. It will, of course, be appreciated by one of ordinary skill in the art that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated by one of ordinary skill in the art that such a development effort might be complex and time consuming, but would nevertheless be a routine undertaking of engineering for those of ordinary skill in the art having the benefit of this disclosure.

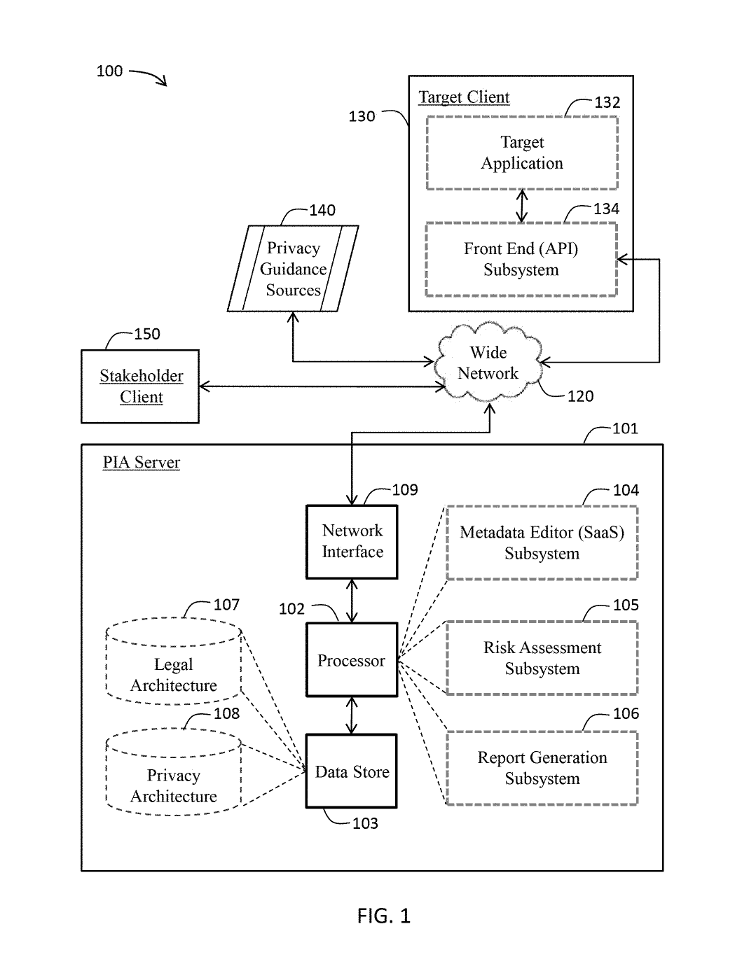

Referring to FIGS. 1-11, a privacy impact assessment system (PIAS) according to an embodiment of the present invention is now described in detail. Throughout this disclosure, the present invention may be referred to as an impact assessment system, a privacy verification system, a risk assessment system, an assessment system, a privacy assessment service, a risk assessor, a risk compliance tool, a device, a system, a product, a service, and a method. Those skilled in the art will appreciate that this terminology is only illustrative and does not affect the scope of the invention. For instance, the present invention may just as easily relate to privacy data manipulation and computing forensics technology.

Example systems and methods for privacy impact assessment system are described herein below. In the following descriptors for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation.

Referring now to FIG. 1, a Privacy Impact Assessment System 100 will now be discussed. For example, and without limitation, the Privacy Impact Assessment System 100, according to an embodiment of the present invention, may include a Privacy Impact Assessment (PIA) Server 101, which may be in data communication with a Target Client 130 and/or a Stakeholder Client 150. The Target Client 130 and/or Stakeholder Client 150 each may be coupled to the PIA Server 101 using a wide area network 120 such as the Internet. The PIA Server 101 also may have access to various third-party Privacy Guidance Sources 140 via the Internet 120.

More specifically, the Target Client 130 may comprise a mobile device or a workstation. For example, and without limitation, the mobile device 130 may be a cell phone, smart phone, notebook computer, a tablet personal computer (PC), or a personal digital assistant (PDA). Also for example, and without limitation, the workstation 130 may be a desktop computer or a laptop computer. Either the mobile device 130 or workstation 130 may be configured in data communication with the PIA server 101, for example, and without limitation, using a wide area network 120 such as the Internet. The workstation 130 may be connected to the network 120 via a network server, a network interface device, or any other device capable of making such a data communication connection. The mobile device 130 may be configured to be connected with the network 120 via a hotspot that, for example, may employ a router connected to a link to the network 120. For example, and without limitation, the mobile device 130 may be connected to the Internet 120 by a wireless fidelity (WiFi) connection to the hotspot described above. Also for example, and without limitation, the mobile device 130 may be configured to be connected with the network 120 via a mobile network (not shown) that may be any type of cellular network device, including GSM, GPRS, CDMA, EV-DO, EDGE, 3G, DECT, OFDMA, WIMAX, and LTE™ communication devices. These and other communication standards permitting connection to a network 120 may be supported within the invention. Moreover, other communication standards connecting the mobile device 130 with an intermediary device that is connected to the Internet, such as USB, FireWire, Thunderbolt, and any other digital communication standard may be supported by the invention.

For example, and without limitation, the Target Client 130 may be configured to host data processes, such as a software program (defined as a Target Application 132) that may be in the form of source code that may involve privacy data. The Target Application 132 may comprise a plurality of complementary software-based applications. For example, and without limitation, the Target Application 132 may comprise a web browser and a communication application. “Web browser” as used herein includes, but is not limited to, any application software or program (including mobile applications) designed to enable users to access online resources and conduct trusted transactions over a wide network such as the Internet. “Communication” as used herein includes, but is not limited to, electronic mall (email), instant messaging, mobile applications, personal digital assistant (PDA), a pager, a fax, a cellular telephone, a conventional telephone, television, video telephone conferencing display, other types of radio wave transmitter/transponders and other forms of electronic communication. Those skilled in the art will recognize that other forms of communication known in the art are within the spirit and scope of the present invention.

A typical user of a Target Client 130 may be a prospective consumer of protected data and/or functions that employ such data (e.g., Target Applications 132) and that are made available by an online resource. A consumer may interact with various servers included in the Privacy Impact Assessment System 100 through the Target Client 130. For example, and without limitation, consumers may include any individual seeking to connect with other online users using a social networking service. Also for example, and without limitation, consumers may include any individuals or companies desiring to conduct business transactions online using an e-commerce website.

The Stakeholder Client 150 may comprise a mobile device or a workstation configured in data communication with the PIA Server 101 through the Internet 120. For example, and without limitation, services (in the form of available applications and components) hosted on the PIA Server 101 may be accessible from the Stakeholder Client 150. Such services typically may manipulate content to which access is restricted, either by privacy policy (e.g., social networking websites) or by commercial necessity (e.g., e-commerce websites).

Continuing to refer to FIG. 1, the PIA Server 101 may comprise a processor 102 that may accept and execute computerized instructions, and also a data store 103 which may store data and instructions used by the processor 102. More specifically, the processor 102 may be configured in data communication with some number of Target Clients 130, Stakeholder Clients 150, and Privacy Guidance Sources 140. The processor may be configured to direct input from other components of the Privacy impact Assessment System 100 to the data store 103 for storage and subsequent retrieval. For example, and without limitation, the processor 102 may be in data communication with external computing resources 130, 140, 150 through a direct connection and/or through a network connection 120 facilitated by a network interface 109.

Metadata Editor Subsystem 104 Instructions, Risk Assessment Subsystem 105 instructions, and Report Generation Subsystem 108 instructions may be stored in the data store 103 and retrieved by the processor 102 for execution. The Metadata Editor Subsystem 104 may advantageously receive and validate metadata (generally defined as “data that describes other data”) representing both privacy compliance rules (e.g., originating from Privacy Guidance Sources 140) and data workflows subject to those rules (e.g., representing a Target Application 132), and may record those metadata into a Legal Architecture 107 and a Privacy Architecture 108, respectively. The Risk Assessment Subsystem 105 may analyze workflow metadata of interest from the Privacy Architecture 108 against applicable privacy rules metadata from the Legal Architecture 107. The Report Generation Subsystem 108 may advantageously generate reports illustrating results of privacy impact assessments, including breach notifications lists and financial quantification of the cost of a detected breach.

In some embodiments of the present invention, the Metadata Editor Subsystem 104 may be used to advantageously generate and deploy a software front-end/Application Programming Interface (“API”) Subsystem 134 to host and execute some or all of the privacy impact assessment functions (e.g., Risk Assessment Subsystem 105 and/or Report Generation Subsystem 106) and data components (e.g., Legal Architecture 107 and/or Privacy Architecture 108) described herein on a computer 130 than may also host the Target Application 132 of analysis interest.

Those skilled in the art will appreciate, however, that the present invention contemplates the use of computer instructions that may perform any or all of the operations involved in privacy impact assessment and reporting, including access request and transaction request processing, authentication services, verification services, personal identification information collection and storage, and trusted transaction risk processing. The disclosure of computer instructions that include Metadata Editor Subsystem 104 instructions, Risk Assessment Subsystem 105 instructions, and Report Generation Subsystem 106 instructions is not meant to be limiting in any way. Those skilled in the art will readily appreciate that stored computer instructions may be configured in any way while still accomplishing the many goals, features and advantages according to the present invention.

With respect to the system 100, it is best characterized as, at its foundation, a combination of two collections of metadata repositories: a Legal Architecture 107 and a Privacy Architecture 108. In order to accomplish desired objectives, the system 100 may employ certain associated software that variously may perform risk assessments, quantification of breaches, preparation of notification lists and/or formal reports for compliance entities, embedding of the Privacy Architecture 108 directly into planned or legacy IT processes, and filling of electronic spreadsheets with analyses of results of forming PIAs.

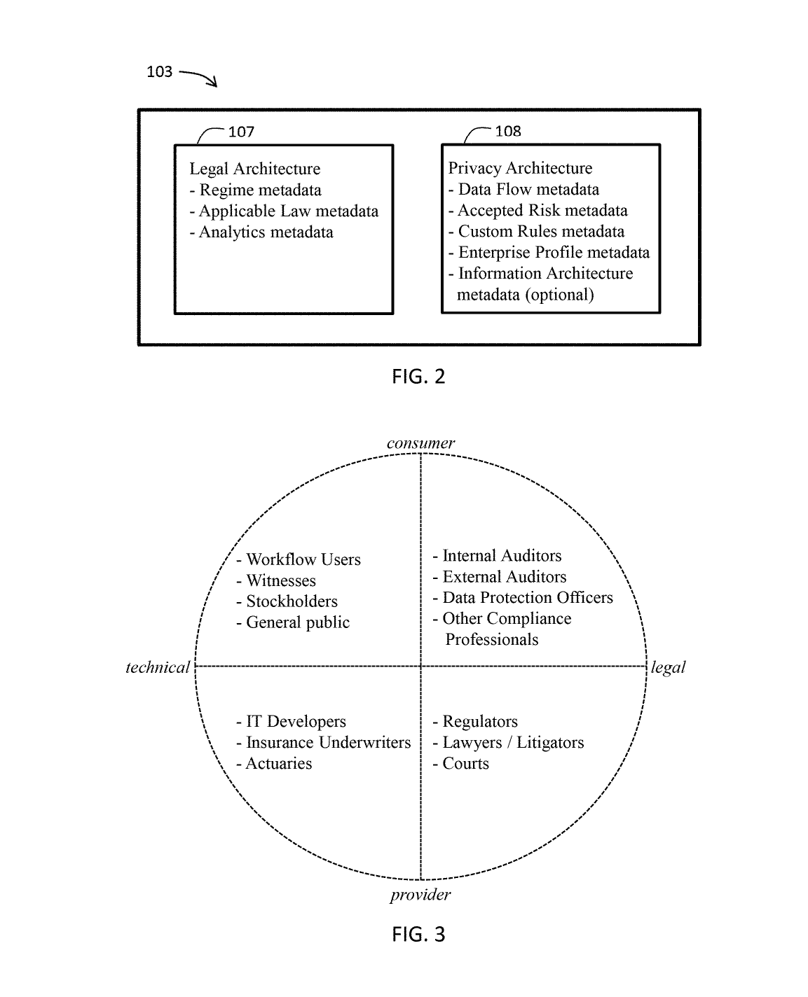

Referring now to FIG. 2, the data structure for a Legal Architecture 107 will now be discussed. Generally speaking, a legal architecture may comprise encapsulations of applicable statute or tort law from any jurisdiction into metadata. The core components that together may make up the Legal Architecture 107 of the system 100 may include the following.

a Regime metadata repository (for multi-jurisdictional capability),

an Applicable Law metadata repository (statutes; torts, treaties), and

an Analytics metadata repository (legal components within laws)

Continuing to refer to FIG. 2, for example, and without limitation, the data structure for a Privacy Architecture 108 will now be discussed. Generally speaking, a privacy architecture may comprise encapsulations of automated business processes into metadata. The core components that together may make up the Privacy Architecture 108 of the system 100 may include the following:

a Data flow metadata repository (setting out information-architecture-level metadata attributes of each data flow/process under review),

an Accepted Risk metadata repository (specifying which risks are accepted for analysis purposes),

a Custom Rules metadata repository (for example, and without limitation, to “disapply” laws, “alter” laws, model the future),

an Enterprise Profile (metadata setting out enterprise-specific characteristics and risk appetite); and

an Information Architecture (optional metadata analogous to, and alternatively referred to herein as, a data dictionary in that logical and physical architecture, such as data models and process models, may be reused for developed software).

The Legal Architecture 107 components may be structured such that Regimes may have jurisdictional or treaty or adequacy decision relationships with each other; Applicable Laws may apply Within a Regime or set of Regimes; Analytics (for example, and without limitation, metadata characterizing the legal tests that may be applied by a court) may apply within an Applicable Law. These architectural components may be structured so as to allow the system 100 to define a full logical and physical technical architecture of the legal “infrastructure” against which statutory or other privacy impact assessments may be validated, and within which privacy subjects (i.e., data flow metadata) may be customized by users.

Those skilled in the art will appreciate that the present invention contemplates the use of data structures that may store information supporting any or all of the operations involved in delivering privacy impact assessment services. The disclosure of the exemplary data structures above is not meant to be limiting in any way. Those skilled in the art will readily appreciate that data structures may include any number of additional or alternative real world data sources, and may be configured in any way while still accomplishing the many goals, features and advantages according to the present invention.

Example methods and systems for a Privacy Impact Assessment System (PIAS) are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation Some of the illustrative aspects of the present invention may be advantageous in solving the problems herein described and other problems not discussed which are discoverable by a skilled artisan.

An embodiment of the present invention, as shown and described by the various figures and accompanying text herein, provides a Privacy Impact Assessment System (PIAS) that may implement automated, intelligent selection of existing and emerging privacy laws and jurisdictions (i.e., legal architecture) that may be applicable to the data process being assessed (i.e., privacy architecture). The system may advantageously allow automation of privacy impact assessments. Privacy impact assessment assets may be hosted on two or more physically separate components that may be configured in data communication with each other and/or with the other components of the PIA System 100 using the wide area network 120. Alternatively, a person of skill in the art will recognize that some or all of such communication assets may be collocated on a single computing host. The system 100 also may advantageously allow law-neutral future-proofed Privacy by Design to be embedded into enterprise software as an Application Programming interface (API).

Referring now to FIG. 3, and continuing to refer to FIGS. 1 and 2, the privacy data protection problem space may involve actors whose roles in that space may be related along a continuum ranging from technical to legal (shown on a horizontal axis) and also along a complementary continuum ranging from provider to consumer (shown on a vertical axis). For example, and without limitation, IT developers responsible for authoring source code for a Target Application 132 of interest may be categorized in the technical-provider quadrant Users who make use of that Target Application 132 (i.e., workflow) in the context of normal enterprise operations may be categorized in the technical-consumer quadrant. Continuing, regulators responsible for authoring and/or revising privacy guidelines and/or regulations may be categorized in the legal-provider quadrant. Finally, auditors, data compliance officers, and other compliance professionals responsible for ensuring business workflows of interest satisfy applicable privacy data protection requirements may be categorized m the legal-consumer quadrant. The PIA system 100 described herein may provide a common platform through which actors in all quadrants of the problem space may cooperate toward achievement of privacy data protection objectives, as described in more detail below.

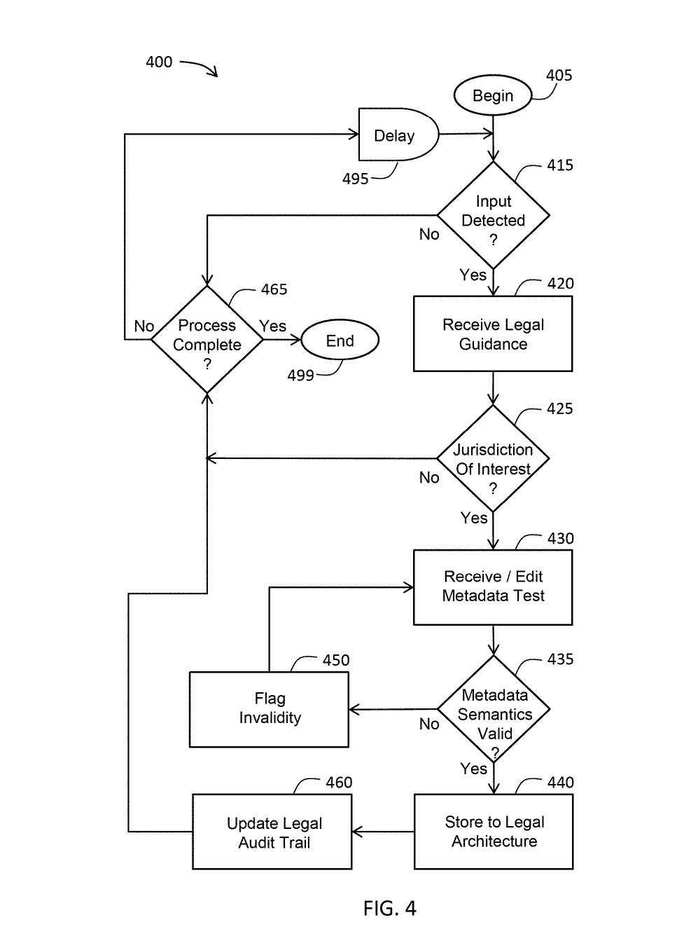

Referring now to FIG. 4, and continuing to refer to FIGS. 1-3, the process 400 of creating and editing a Legal Architecture 107 is discussed in greater detail. From the start at Block 405, the Metadata Editor Subsystem 104 of the PSA Server 101 may detect data input (Block 415) in the form of a data structure representing legal guidance (also referred to herein as applicable law metadata). In one embodiment of the present invention, the data structure may include details of the legal guidance in another embodiment of the present invention, the data structure may include an identifier of the legal guidance and/or an index to the legal guidance. For example, and without limitation, the legal guidance may be transmitted across a network 120 to the PIA Server 101 from a legal-provider (see FIG. 3) user of a stakeholder client 150. Also for example, and without limitation, an originating action on the PIA Server 101 may proactively retrieve legal guidance from some number of privacy guidance sources 140 that may be accessible via a network 120.

Upon receipt of the legal guidance data structure (Block 420), the Metadata Editor Subsystem 104 may determine if the legal guidance data structure relates to a jurisdiction of interest to a legal-consumer (see FIG. 3) user of the subsystem 104 (Block 425). If the detected jurisdiction is not of interest for privacy impact assessment purposes, and if the metadata editing process is not identified (for example, and without limitation, by user acknowledgement) to be complete (Block 485) and therefore ready for termination at Block 499, then the metadata editing process may experience a system-enforced delay at Block 495 before the Metadata Editor Subsystem 104 may attempt to detect subsequent input at Block 415.

If, at Block 425, the detected jurisdiction is determined to be of interest for privacy impact assessment purposes, then Metadata Editor Subsystem 104 of PIA Server 101 may receive from a metadata author a coded expression of the legal guidance detail defined as a metadata test (Block 430). For example, and without limitation, the metadata test may be characterized by an ontology (e.g., a formal naming and definition of the types, properties, and interrelationships of the fundamental features of a specific legal guidance). Such an ontology may advantageously present a common language for expressing privacy rules with sufficient precision such that computers may use expressions of the language to perform a privacy impact assessment. At Block 435, the Metadata Editor System 104 may analyze input metadata to determine semantic validity in keeping with the ontology, invalid metadata may be flagged at Block 450 (for example, and without limitation, the Metadata Editor Subsystem 104 may display an error message highlighting the detected semantic error), and the metadata author may be returned to Block 430 and afforded an opportunity to edit the invalid metadata test. If, at Block 435, a received (or edited) metadata test is determined to be semantically valid, the Metadata Editor System 104 may store the validated metadata to the Legal Architecture 107 for subsequent use during privacy impact assessment, as described in more detail hereinafter.

In one embodiment of the present invention, the Metadata Editor Subsystem 104 of PIA Server 101 may be used at Block 430 by a metadata author to modify metadata in a way that may diverge from detail of a particular legal guidance, for example, and without limitation, to instead align the modified metadata with alternative (even contrary) guidance received from responsible Segal advisors. Such metadata modification, referred to herein as tuning of the Legal Architecture 107, may introduce the possibility of a metadata author gaming the Legal Architecture 107 (defined as bypassing and/or corrupting privacy guidance controls that otherwise may expose privacy risks). To monitor tuning actions for gaming, at Block 460 the Metadata Editor Subsystem 104 may automatically record an audit trail of any tuning made to the Legal Architecture 107 for subsequent inspection by legal-consumers (see FIG. 3) such as auditors and/or quality control personnel, as needed. In one embodiment of the present invention, the Metadata Editor Subsystem 104 may facilitate inspection of suspected ants-gaming incidents by creating and transmitting a notification to interested parties that includes the collected audit trail.

After successful storage of metadata to the Legal Architecture 107 (Block 440) and successful recording of any tuning to the audit trail (Block 480), if the metadata editing process is not identified to be complete (Block 465) and therefore ready for termination at Block 499, then the Metadata Editor Subsystem 104 may attempt to detect subsequent input at Block 415 after a system-enforced delay at Block 495.

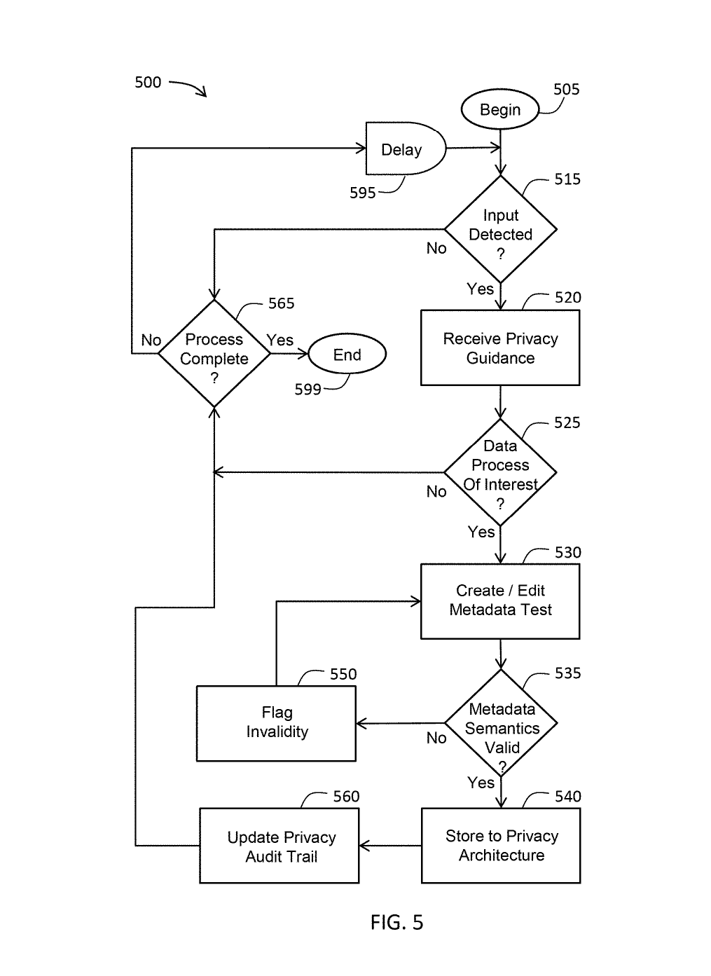

Referring now to FIG. 5, and continuing to refer to FIGS. 1-3, the process 500 of creating and editing a Privacy Architecture 108 is discussed in greater detail. From the start at Block 505, the Metadata Editor Subsystem 104 of the PIA Server 101 may detect data input (Block 515) in the form of a data structure representing privacy guidance that may include data flow metadata directed to an automated process involving privacy information. In one embodiment of the present invention, the data structure may include details of a single, transaction-level software source code component that may include algorithms for manipulation of privacy information. In another embodiment of the present invention, the data structure may include an identifier of and/or index to a collection of data flow metadata for which responsibility to protect privacy information within those data flows is shared by a common enterprise For example, and without limitation, the privacy guidance may be transmitted across a network 120 to the PIA Server 101 from a technical-provider (see FIG. 3) user of a stakeholder client 150. Also for example, and without limitation, an originating action on the PIA Server 101 may proactively retrieve the privacy guidance from a target client 132 that may be accessible via a network 120.

Upon receipt of the privacy guidance data structure (Block 520), the Metadata Editor Subsystem 104 may determine if the privacy guidance data structure relates to an enterprise and/or a transaction of interest to a technical-consumer (see FIG. 3) user of the subsystem 104 (Block 525), if the detected enterprise/transaction is not of interest for privacy impact assessment purposes, and if the metadata editing process is not identified (for example, and without limitation, by user acknowledgement) to be complete (Block 585) and therefore ready tor termination at Block 599, then the metadata editing process may experience a system-enforced delay at Block 595 before the Metadata Editor Subsystem 104 may attempt to detect subsequent input at Block 515.

If, at Block 525, the detected enterprise/transaction is determined to be of interest for privacy impact assessment purposes, then Metadata Editor Subsystem 104 of PIA Server 101 may receive from a metadata author a coded expression of the privacy guidance detail, defined as a metadata test (Block 530). As described above, the metadata test may be characterized by the same ontology used for legal guidance handling, thus advantageously presenting a common language for expressing operational designs with sufficient precision such that computers may use expressions of the language to perform a privacy impact assessment. At Block 536, the Metadata Editor System 104 may analyze input metadata to determine semantic validity in keeping with the ontology. Invalid metadata may be flagged at Block 550 (for example, and without limitation, the Metadata Editor Subsystem 104 may display an error message highlighting the detected semantic error), and the metadata author may be returned to Block 530 and afforded an opportunity to edit the invalid metadata test, if, at Block 535, a received (or edited) metadata test is determined to be semantically valid, the Metadata Editor System 104 may store the validated metadata to the Privacy Architecture 108 for subsequent use during privacy impact assessment, as described in more detail hereinafter.

In one embodiment of the present invention, the Metadata Editor Subsystem 104 of PIA Server 101 may be used at Block 530 by a metadata author to modify metadata (e.g., tune the Privacy Architecture 108) in a way that may diverge from detail of a particular privacy guidance, for example, and without limitation, to instead align the modified metadata with alternative (even contrary) guidance received from responsible technical advisors. As described above for tuning of the Legal Architecture 107, tuning may empower a metadata author to similarly game the Privacy Architecture 100 by bypassing and/or corrupting privacy guidance controls that otherwise may expose privacy risks To monitor tuning actions for gaming, at Block 560 the Metadata Editor Subsystem 104 may automatically record an audit trail of any tuning made to the Privacy Architecture 108 for subsequent inspection by legal-consumers (see FIG. 3) such as auditors and/or quality control personnel, as needed.

After successful storage of metadata to the Privacy Architecture 108 (Block 540) and successful recording of any tuning to the audit trail (Block 560), if the metadata editing process is not identified to be complete (Block 585) and therefore ready for termination at Block 599, then the Metadata Editor Subsystem 104 may attempt to detect subsequent input at Block 515 after a system-enforced delay at Block 595.

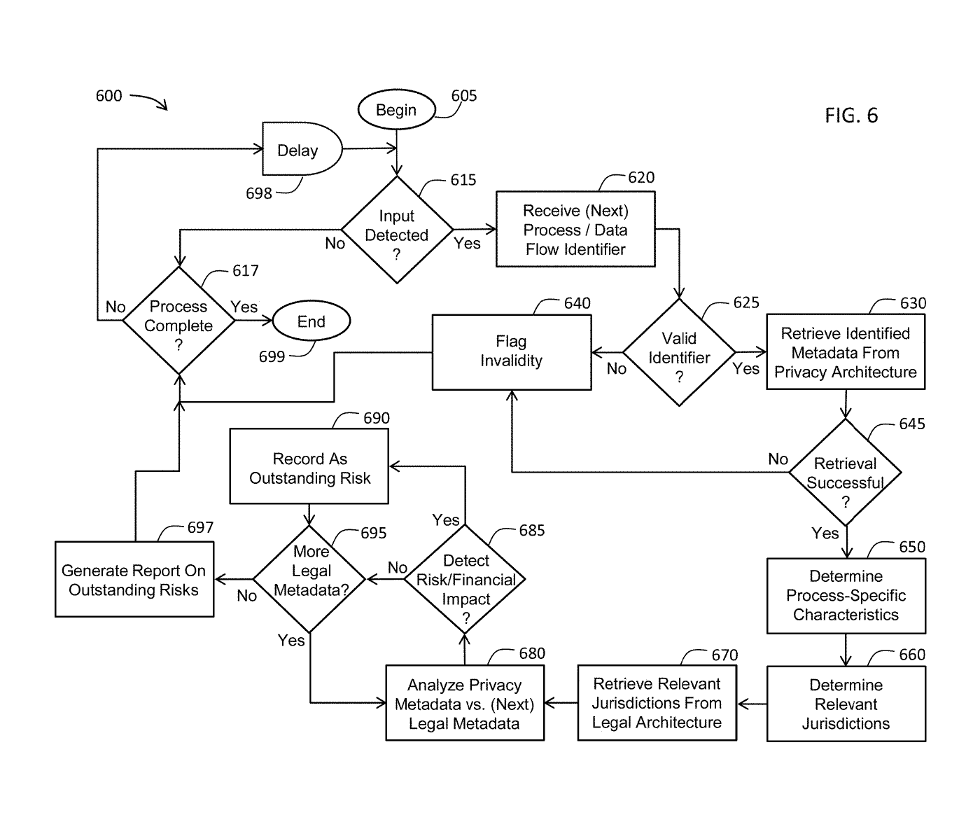

Referring now to FIG. 6, and continuing to refer to FIGS. 1-3, the process 600 of performing privacy impact assessment (i.e., risk assessment) and reporting is discussed in greater detail. From the start at Block 605, the Risk Assessment Subsystem 105 of the PIA Server 101 may detect data input (Block 615) in the form of a request to analyze a data flow for risks to privacy information, in one embodiment of the present invention, the request may include an identifier or and/or index to the data flow that is the target of the risk assessment. In another embodiment of the present invention, the request may be m the form of detected execution of the data flow (e.g., operating system call to one or more transactional software routines of interest). For example, and without limitation, the request may be transmitted across a network 120 to the PIA Server 101 from a technical-consumer (see FIG. 3) user of a target application 132 that may be hosted on a target client 130. Also for example, and without limitation, a legal-consumer (see FIG. 3) using the PIA Server 101 may originate the request for analysis.

If no request is detected, and if the risk assessment process is not identified (for example, and without limitation, by user acknowledgement) to be complete (Block 617) and therefore ready for termination at Block 699, then the risk assessment process may experience a system-enforced delay at Block 698 before the Risk Assessment Subsystem 105 may attempt to detect subsequent input at Block 615. If, upon receipt of the data flow/identifier (Block 620), the Risk Assessment Subsystem 105 determines that the data flow/identifier does not resolve to a valid candidate for risk assessment (Block 625), then the Risk Assessment Subsystem 105 may flag the invalid input (e.g., display an error message) before determining whether to continue processing (Blocks 617 and 698) or to terminate processing (Blocks 617 and 699).

If, at Block 625, the data flow/identifier resolves to a valid candidate for risk assessment, then Risk Assessment Subsystem 105 of PIA Server 101 may retrieve from the Privacy Architecture 108 a stored metadata test for the identified data flow (Block 630). If the retrieval action fails (e.g., no metadata test for the data flow of interest exists in the Privacy Architecture 108), then the Risk Assessment Subsystem 105 may flag the invalid input as described above (Block 640) before determining whether to allow the user to revise the data flow/identifier (Blocks 617, 698, 615, 620) or to terminate the risk assessment process (Blocks 617 and 699). If the retrieval action succeeds at Block 645, then the metadata test for the data flow of interest may be analyzed by the Risk Assessment Subsystem 105 to determine process-specific characteristics (Block 650) that may be pertinent to privacy (described in more detail below).

At Block 660, the Risk Assessment Subsystem 105 may analyze the process-specific characteristics of the retrieved metadata to determine the jurisdiction(s) that may be relevant to the target data flow in terms of applicable privacy rules. Metadata test(s) for the relevant jurisdictions may be retrieved by the Risk Assessment Subsystem 105 from the Legal Architecture 107 and used to analyze the data flow metadata tests vis-à-vis the relevant privacy rules metadata tests (Block 680). The privacy impact assessment performed by the Risk Assessment Subsystem 105 may determine that the target data flow(s) may pose risk to privacy information and/or financial exposure due to privacy information handling (Block 685). Each risk/financial impact may be recorded (Block 690), as appropriate, for each legal metadata test deemed to be relevant (Block 695). After all relevant legal metadata tests have been successfully applied to the target data flow(s) metadata tests, the Report Generation Subsystem 106 may create a report that may, in one embodiment, include description of the recorded outstanding risks (Block 697). In another embodiment, the generated report may include audit trails associated with false negative processing (i.e. scenarios which ordinarily are excluded by any automated risk assessment process), by virtue of anti-gaming mechanisms (as described above) allowing regulators, auditors and/or compliance staff to inspect every change users may have made to the Legal Architecture 107 and/or the Privacy Architecture 108. The Risk Assessment Subsystem 105 may then determine whether to allow the user to continue privacy impact assessment processing using a new/revised data flow(s) (Blocks 617, 698, 615, 620) or to terminate the risk assessment process (Blocks 617 and 699).

To summarize, the PIA system 100 may advantageously employ the Legal Architecture 107 to perform privacy data risk analyses (of various kinds) against the Privacy Architecture 108. These analyses may advantageously provide financially-quantified privacy impact assessments for workflows at the level of abstraction of an entire organization. Alternatively, or in additional, these analyses may advantageously provide in-code Privacy by Design testing for individual data subjects, requiring coding just once while future-proofing a business against future changes to law. The system 100 also may advantageously allow direct injection of the same logic as used in the PIA directly into new and legacy IT systems at a transactional level (e.g., privacy data employed, and Jurisdiction-driving variables present), so as to provide an enterprise with “fire-and-forget” multi-jurisdictional Privacy by Design for a Target Application 132 despite not requiring the enterprise IT architects and software designers to know anything at all about privacy law in any jurisdiction, as described in more detail below.

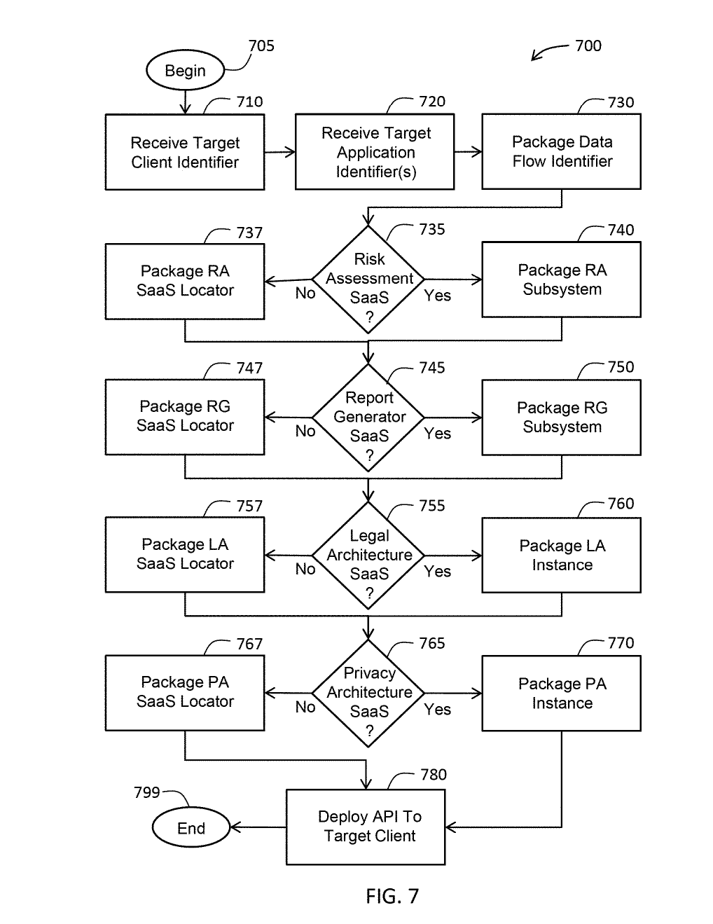

Referring now to FIG. 7, and continuing to refer to FIGS. 1-3, the process 700 of packaging and deploying a “fire-and-forget” Front End (API) Subsystem 134 to a target client 130 is discussed in greater detail. From the start at Block 705, the Metadata Editor Subsystem 104 of the PIA Server 101 may receive an identifier for a target client 130 to which a front end (i.e., API) 134 may be deployed (Block 710), and also identifiers for one or more target applications 132 for which privacy impact assessment is desired (Block 720). The Metadata Editor Subsystem 104 may then package some desired combination of privacy impact assessment system (100) applications and/or components for inclusion in a front end subsystem 134 for stand-alone deployment to the target client 130. Applications and/or components not included in the API 134 may instead be accessed remotely via a Software as a Service (SaaS) configuration (e.g., API 134 executing on target client 130 may make a call to the needed applications/components hosted remotely on a PIA Server 101).

For example, and without limitation, at Block 730 the Metadata Editor Subsystem 104 may analyze the target application identifiers from Block 720 and, using the results of that analysis, may create an associated data flow identifier in a format acceptable as input to a Risk Assessment Subsystem 105 (as illustrated in Block 620 of FIG. 6). At Block 735, the Metadata Editor Subsystem 104 may prompt a user to choose either to package into the API 134 a complete Risk Assessment Subsystem (Block 740), or to package into the API 134 a locator that may point to a Risk Assessment Subsystem 105 executing on a remote server 101 (Block 737). Similarly, the Metadata Editor Subsystem 104 may prompt the user (Block 745) to choose to package into the API 134 either a complete Report Generation Subsystem (Block 750) or a locator for a remote Report Generation Subsystem 106 (Block 747). The Metadata Editor Subsystem 104 also may prompt the user (Block 755) to choose to package into the API 134 either a complete Legal Architecture (Block 760) or a locator for a remote Legal Architecture 107 (Block 757). The Metadata Editor Subsystem 104 also may prompt the user (Block 765) to choose to package into the API 134 either a complete Privacy Architecture (Block 770) or a locator for a remote Privacy Architecture 108 (Block 767).

In its most complete version, the present invention is made up of either of the two front-ends set out above plus all of the other components set out above (either co-located or distributed). User-directed packaging of privacy impact assessment system 100 applications and/or components into a front end (API) 134 advantageously may empower a user to adapt to system configuration constraints. For example, and without limitation, if processing cycles are at a premium on a target client 130, then computationally-demanding Risk Assessment Subsystem processing may be relegated to a remote server, as described above. Also for example, and without limitation, if data storage space on a target client 130 is limited, then potentially large data components (e.g., legal architecture and/or privacy architecture) may be made available by server call rather than packaged in the API.

After successful packaging of an API, as described above, the Metadata Editor Subsystem 104 may deploy the user-defined API to the target client 130 (Block 730) before the process 700 may terminate at Block 799.

Embodiments of the present invention are described herein in the context of a system of computers, servers, and software. Those of ordinary skill in the art will realize that the embodiments of the present invention described above are provided as examples, and are not intended to be limiting in any way. Other embodiments of the present invention will readily suggest themselves to such skilled persons having the benefit of this disclosure.

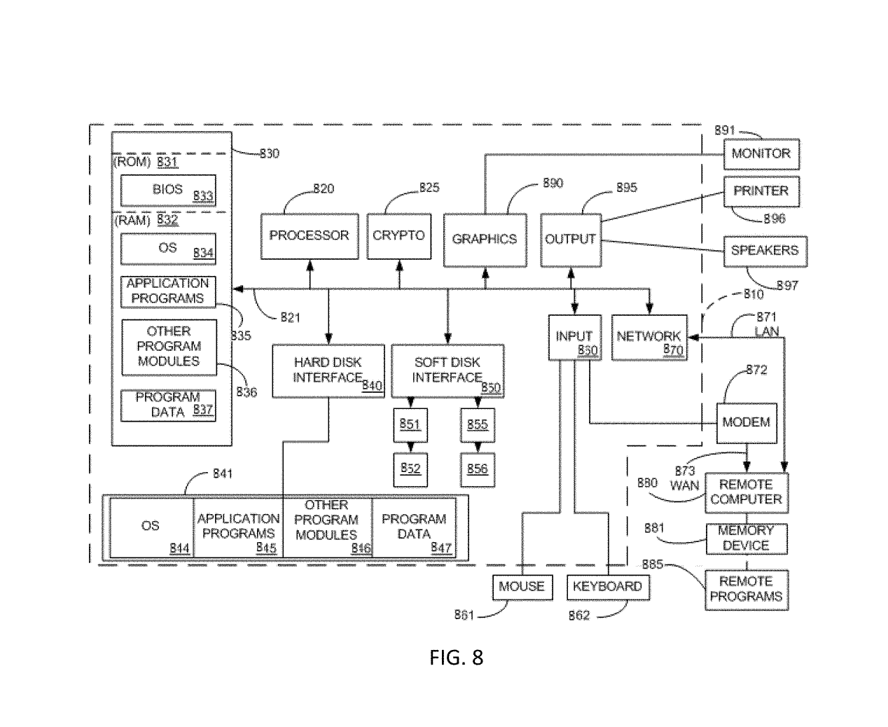

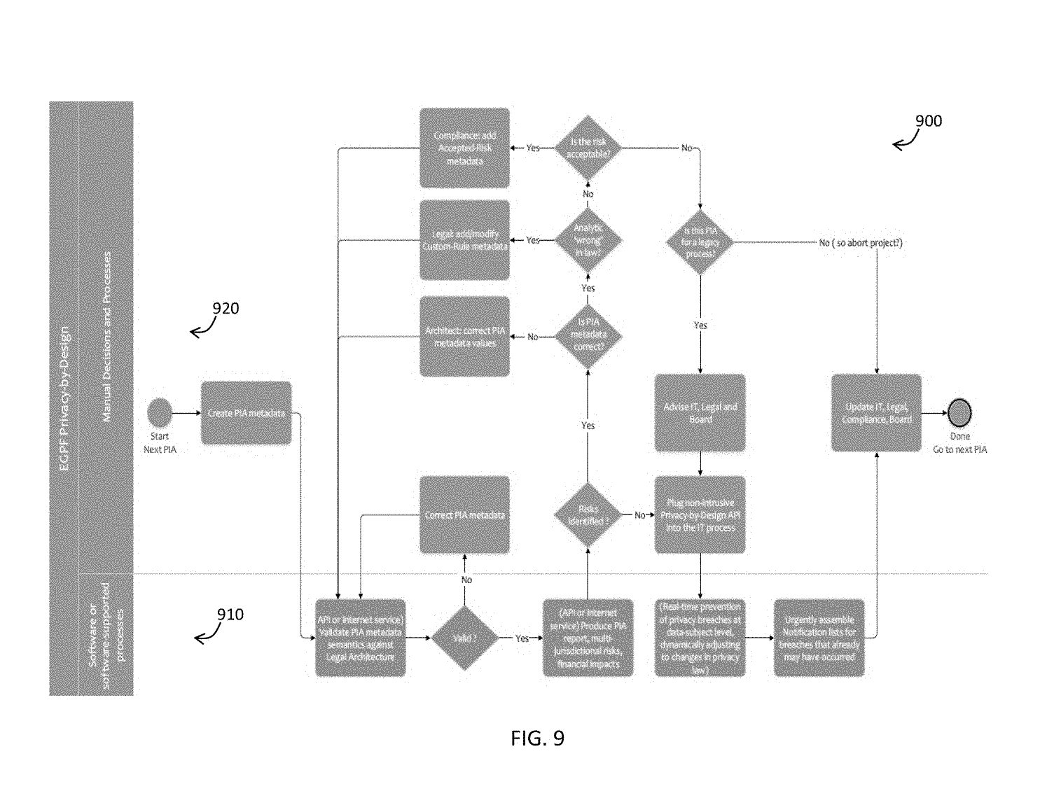

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 8 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 826 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed fey a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 320. By way of example, and not limitation, FIG. 8 illustrates an operating system (OS) 834, application programs 335, other program modules 838, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic-media, a magnetic disk drive 351 that reads from or writes to a removable, nonvolatile magnetic disk 852, and an optical disk drive 855 that reads from or writes to a removable, nonvolatile optical disk 858 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital videotape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 8, provide storage of computer readable instructions, data structures, program modules and other data for the computer 810. In FIG. 8, for example, hard disk drive 841 is illustrated as storing an OS 844, application programs 845, other program modules 848, and program data 847. Note that these components can either be the same as or different from OS 833, application programs 833, other program modules 836, and program data 837. The OS 844, application programs 845, other program modules 848, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has bean illustrated in FIG. 8. The logical connections depicted in FIG. 8 include a local area network (LAN) 871 and a wide area network (WAN) 873, hut may also include other networks 140. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 831.

The communications connections 870 and 872 allow the device to communicate with other devices. The communications connections 870 and 872 are an example of communication media. The communication media typically embodies computer readable instructions, data structures, program modules or other data in a modulated data signal such as a earner wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

Referring now to FIG. 9, and continuing to refer to FIG. 1, a method aspect of a user interacting with software processes of the PIA system 100 is described in detail. Software or software-supported processes are shown below the line 910. Manual decisions and processes accomplished by a user are shown above the line 920.

Software-supported processes may include validating PIA metadata semantics against a Legal Architecture 107 using the Metadata Editor Subsystem 104 (see also Blocks 430, 435, 440, 450, and 460 of FIG. 4). Editing of PIA metadata may be required to correct semantic errors, or to make post-assessment revisions (e.g., correct values, modify custom rules, add accepted risks). Software-supported processes may also include using the Risk Assessment Subsystem 105 in cooperation with the Report Generation Subsystem 106 to produce a PIA report that may include multi-jurisdictional risks identified and associated financial impacts (see also Blocks 650, 660, 670, 680, 685, 690, 695, and 697 of FIG. 6). Software-supported processes also may include packaging and deploying an API (see also FIG. 7) to perform PIA analysis and reporting (see also FIG. 6).

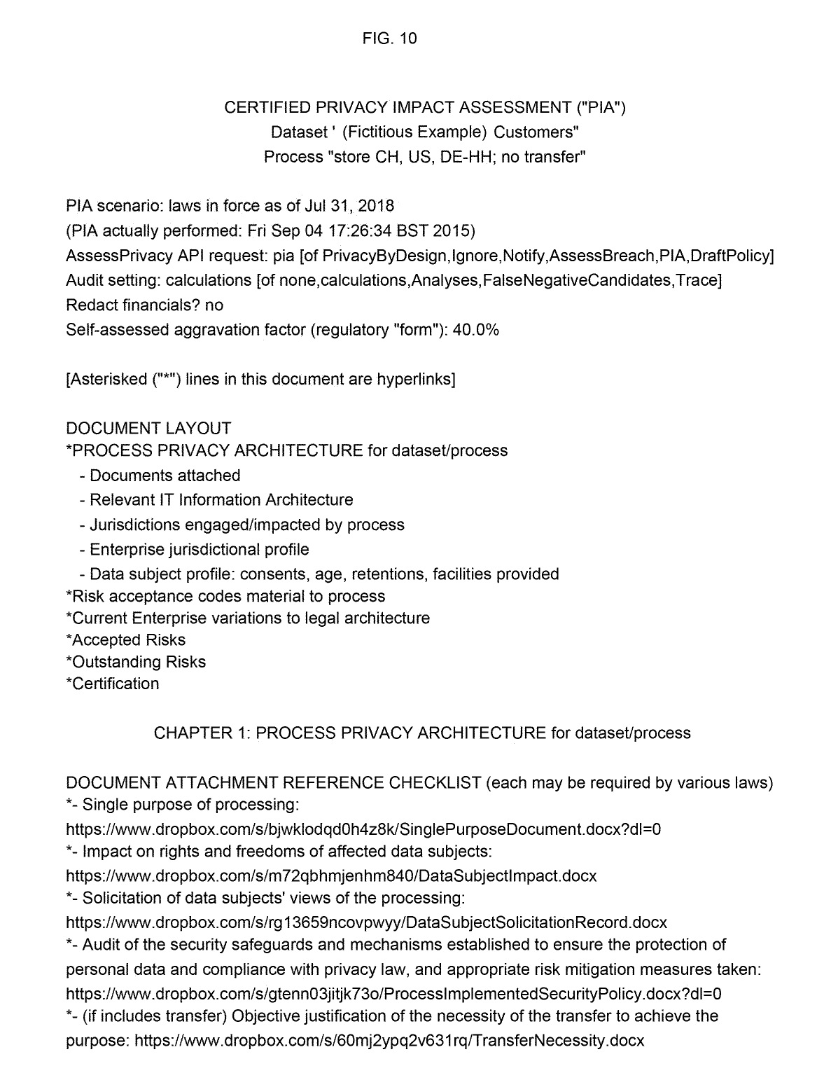

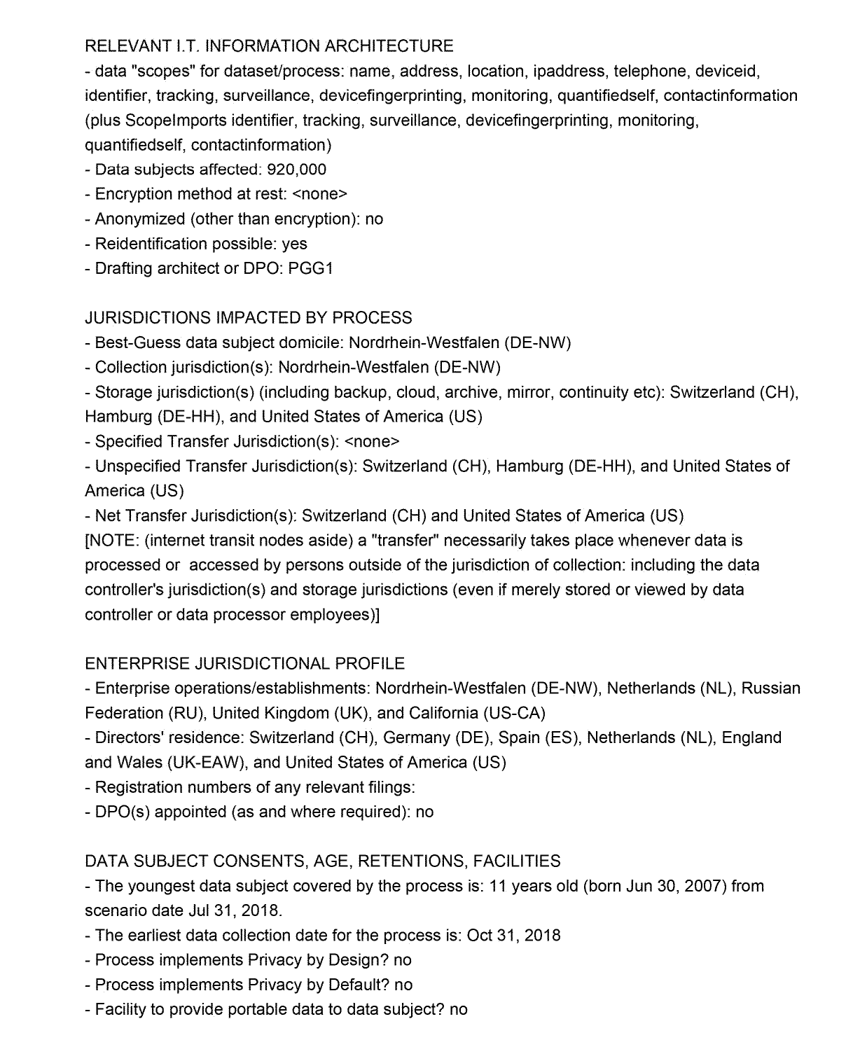

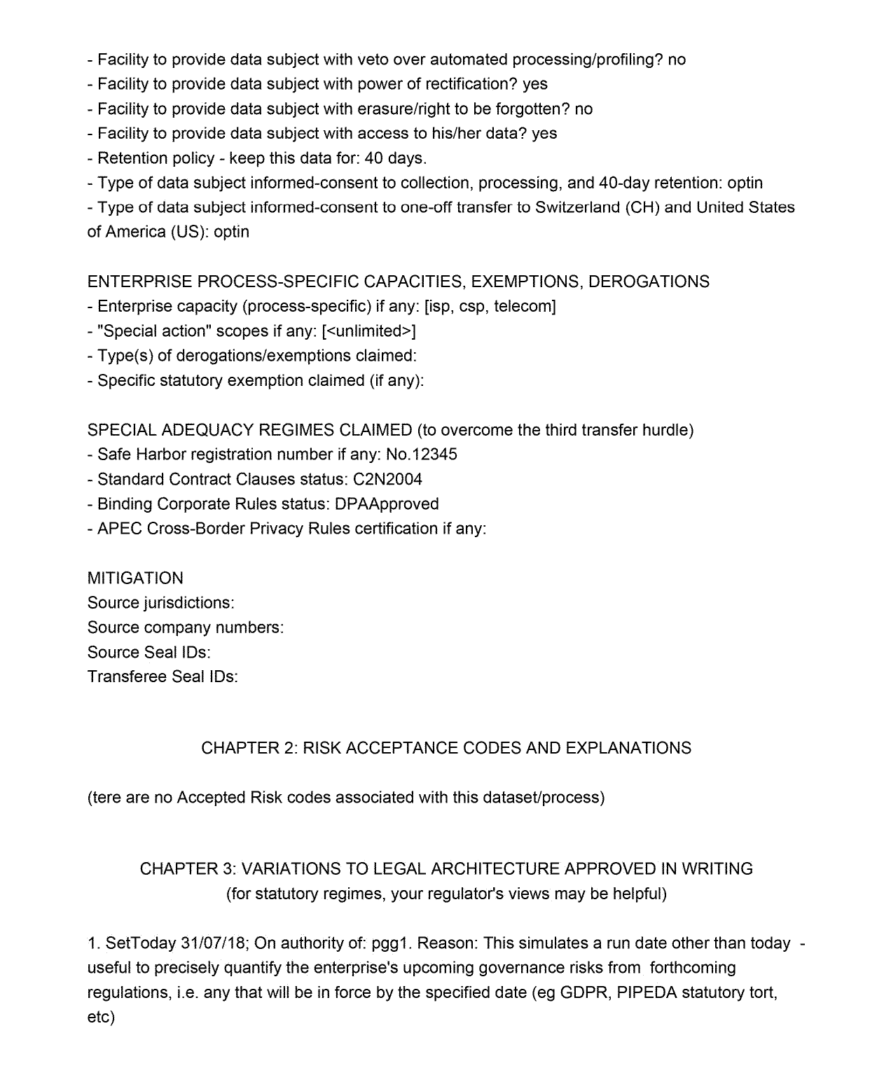

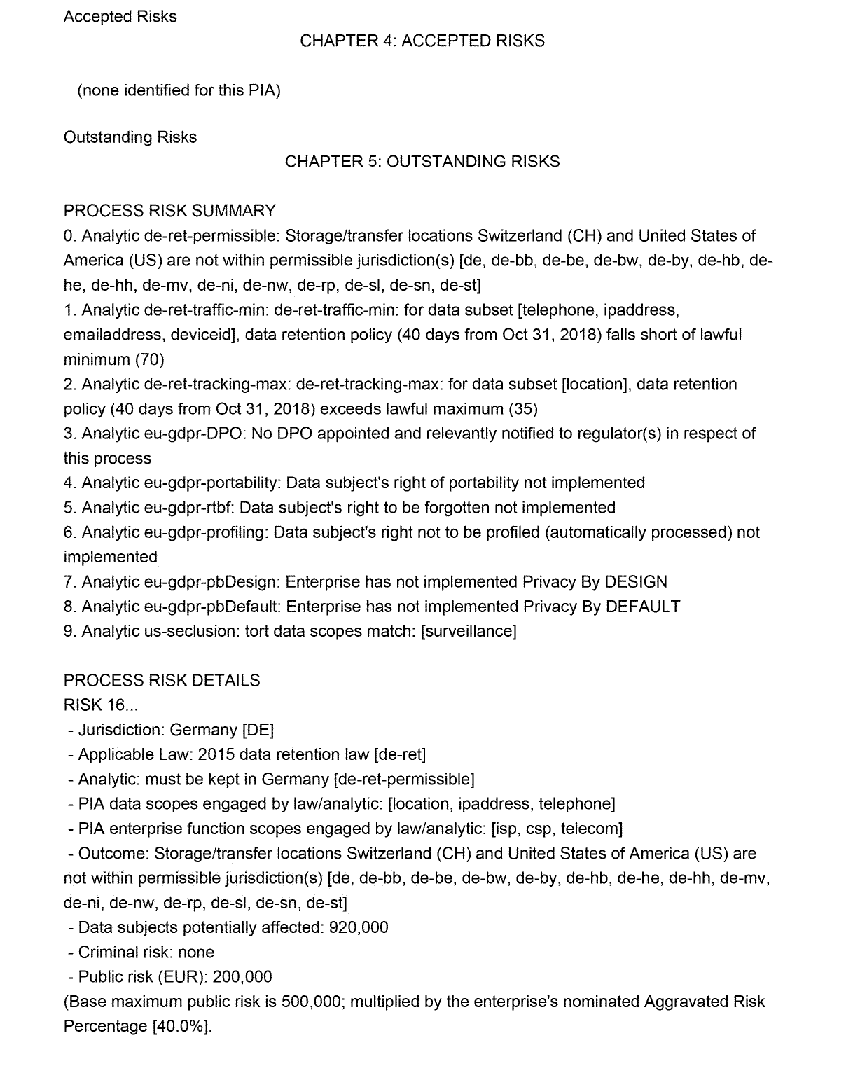

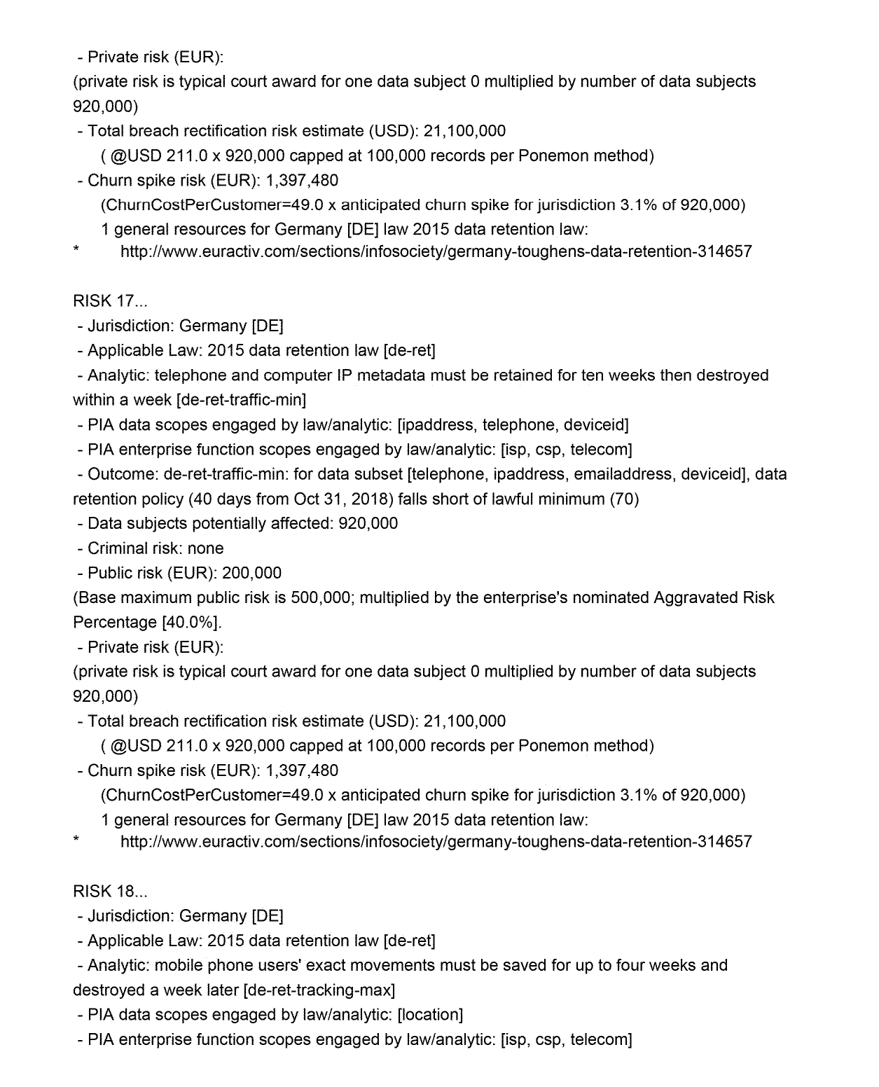

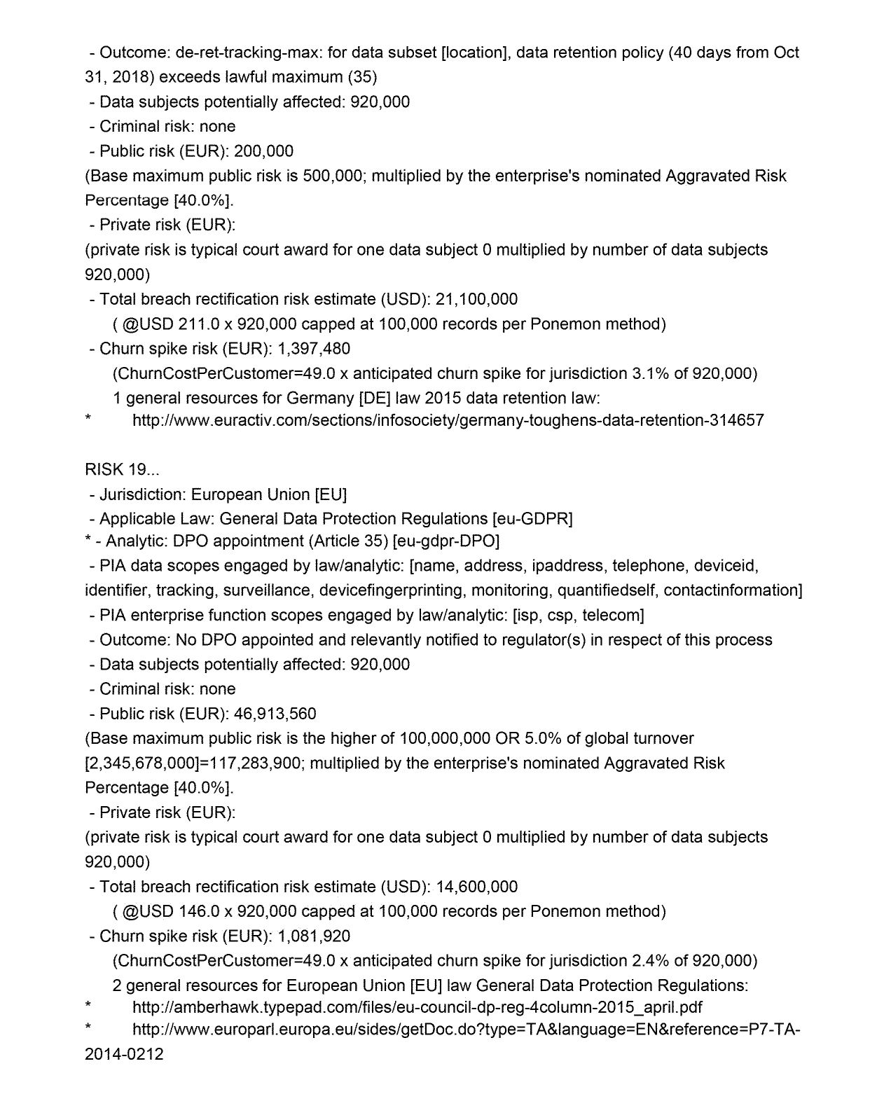

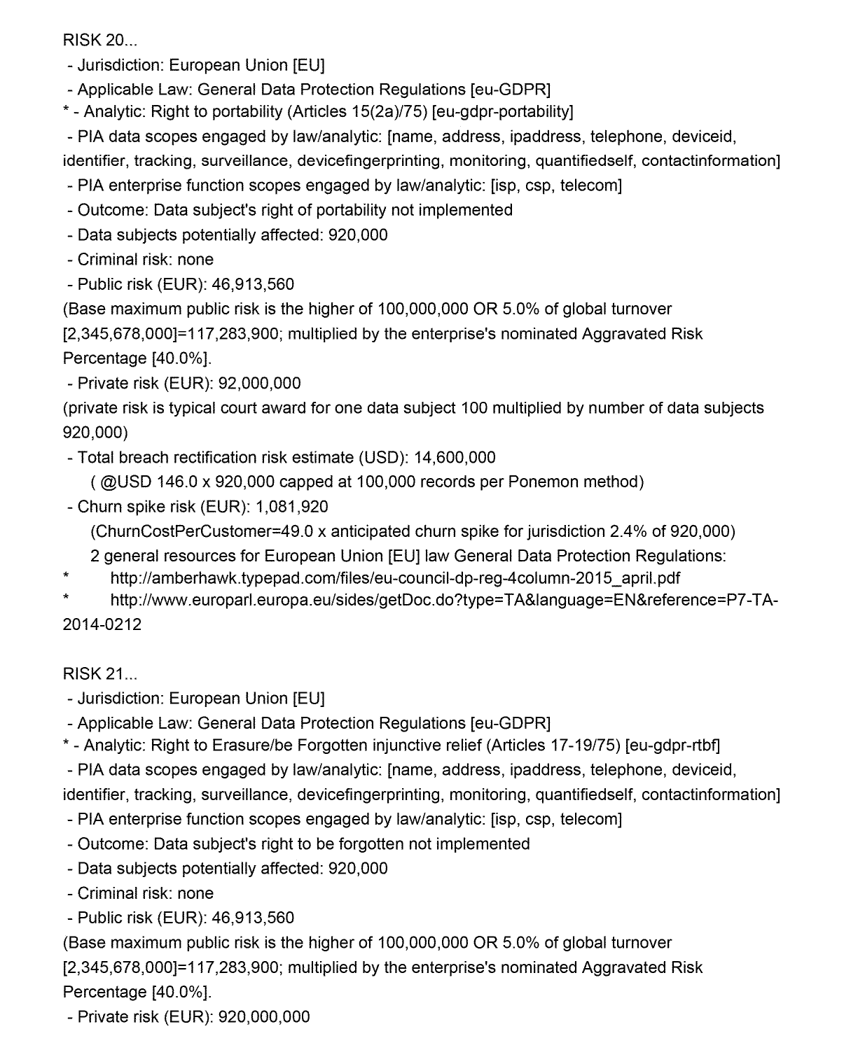

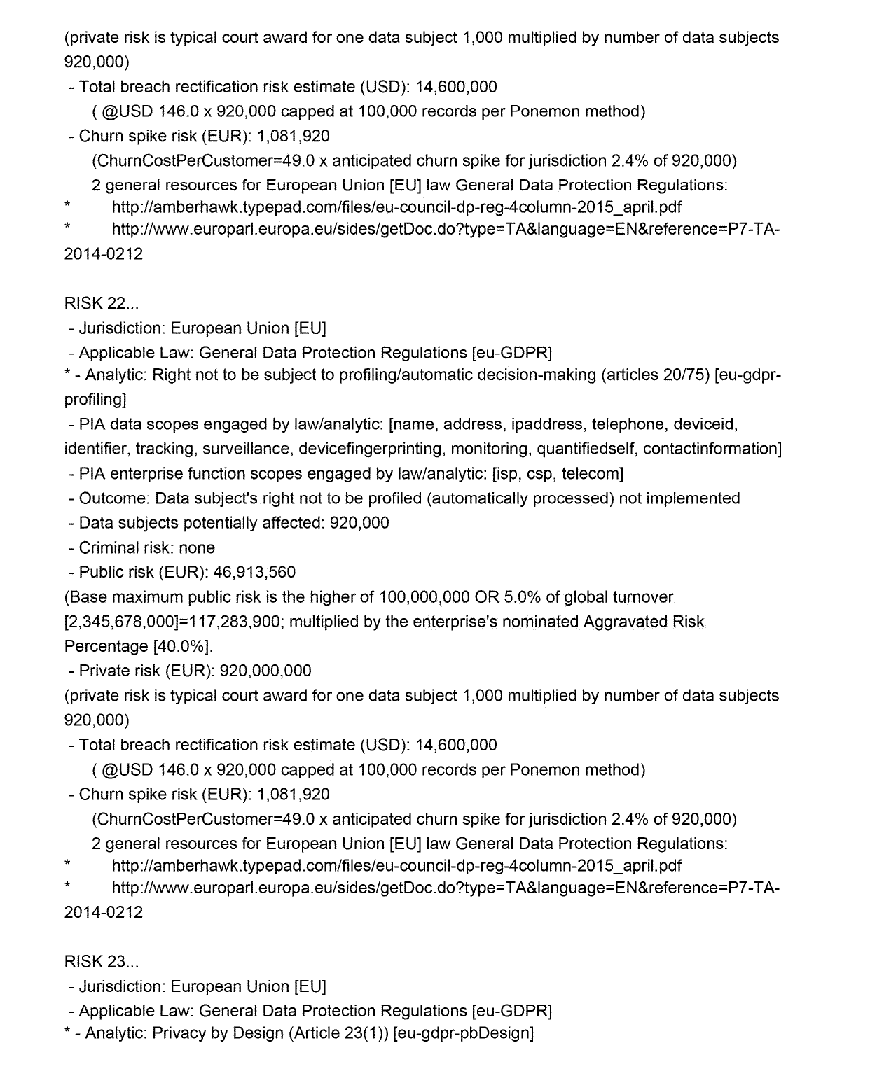

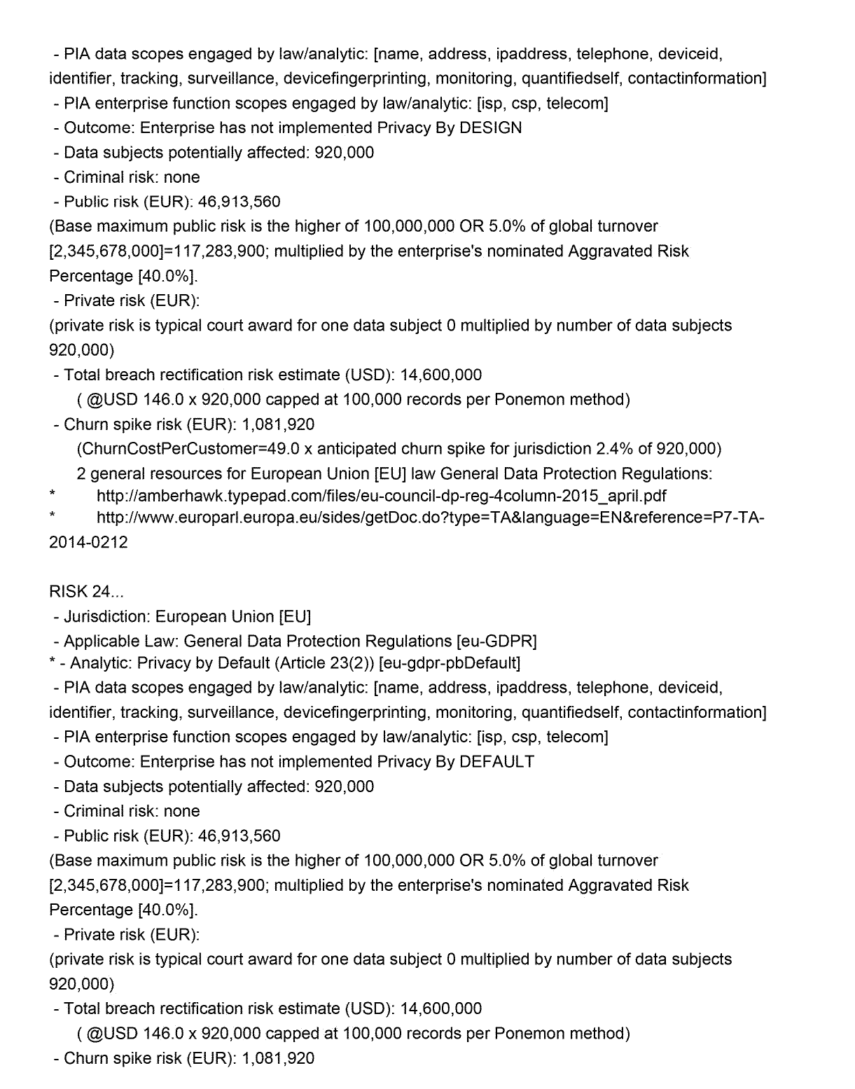

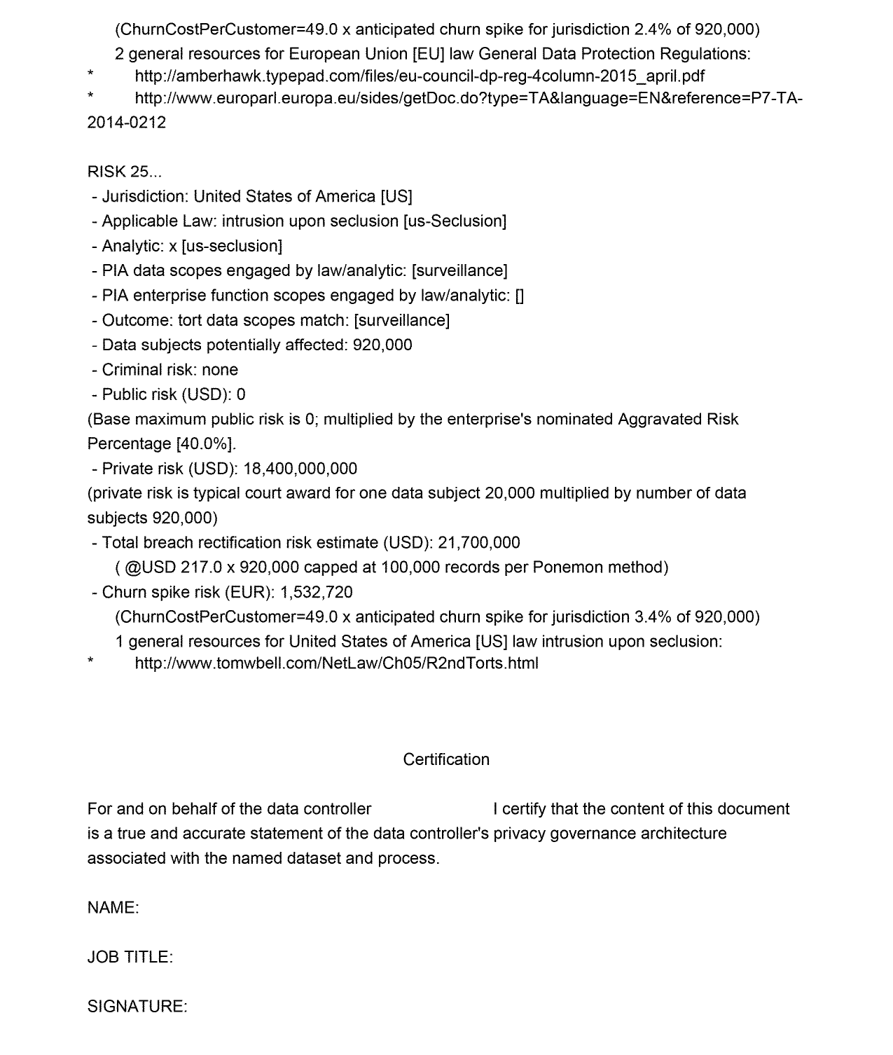

Referring now to FIG. 10, and continuing to refer to FIG. 1, an exemplary PIA report is provided for illustration purposes. For example, and without limitation, the Report Generation Subsystem 106 of the PIA Server 101 may be configured to report the results of analyses in the form of breach notification lists that may be assembled at minimal notice (e.g., hours rather than months, weeks, or the 3 days permitted by the GDPR). Also for example, and without limitation, the Report Generation Subsystem 106 may be configured to report the results of analyses in the form of financially-quantified breach impact assessments. The sample report at FIG. 10 comprises the following sections:

Chapter 1; Privacy Architecture for dataset/process including:
Relevant IT information Architecture
jurisdictions engaged/impacted by process
Enterprise jurisdictional profile
Data subject profile: consents, age, retentions, facilities provided

Chapter 2: Risk acceptance codes material to process

Chapter 3: Current Enterprise variations to legal architecture

Chapter 4: Accepted Risks

Chapter 5: Outstanding Risks (listed findings from executed analyses)

Certification section (to signify review and approval of appropriate authority).

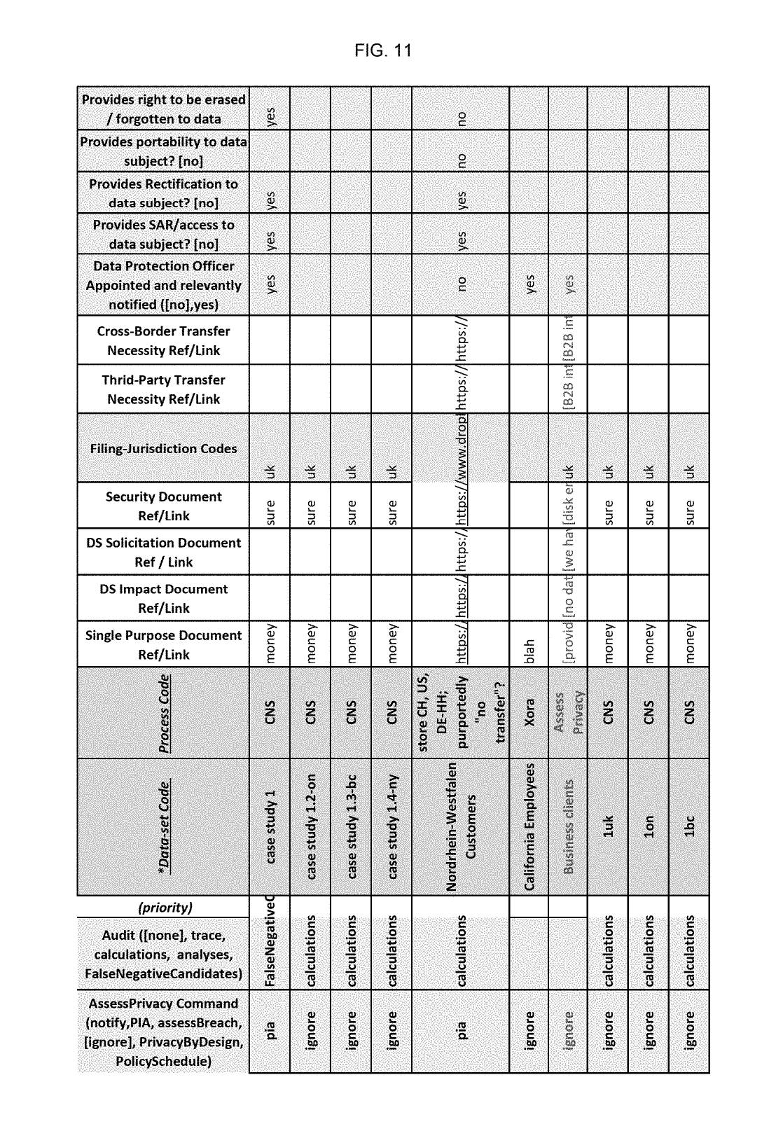

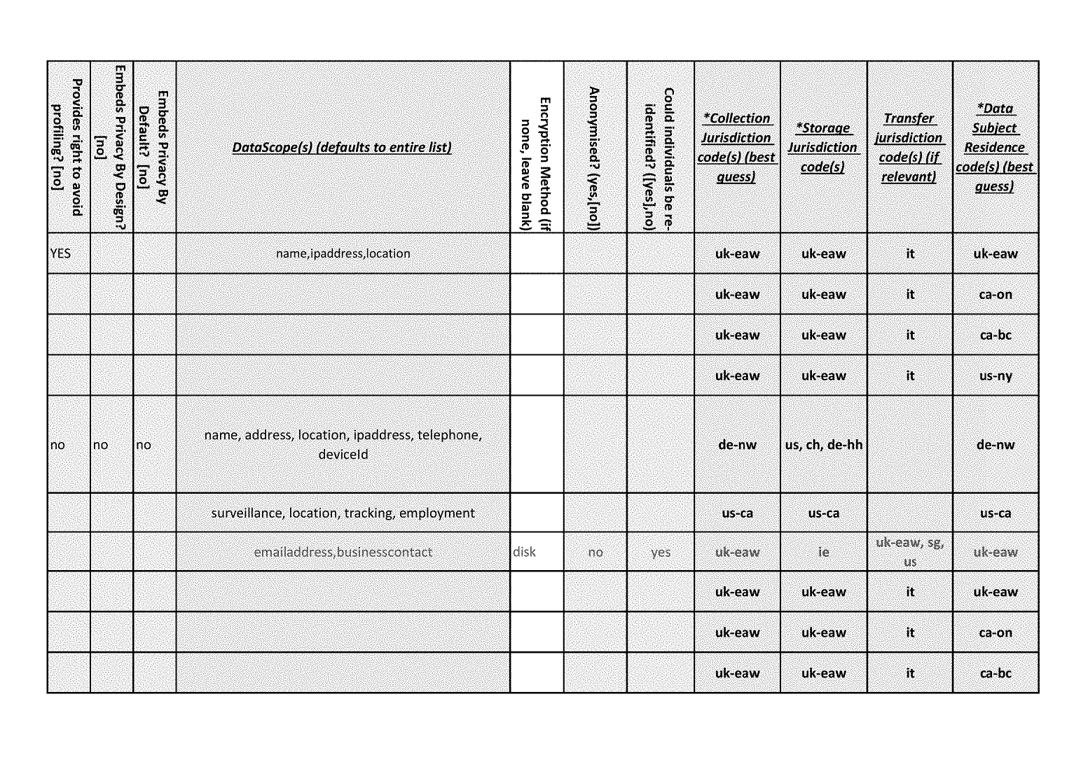

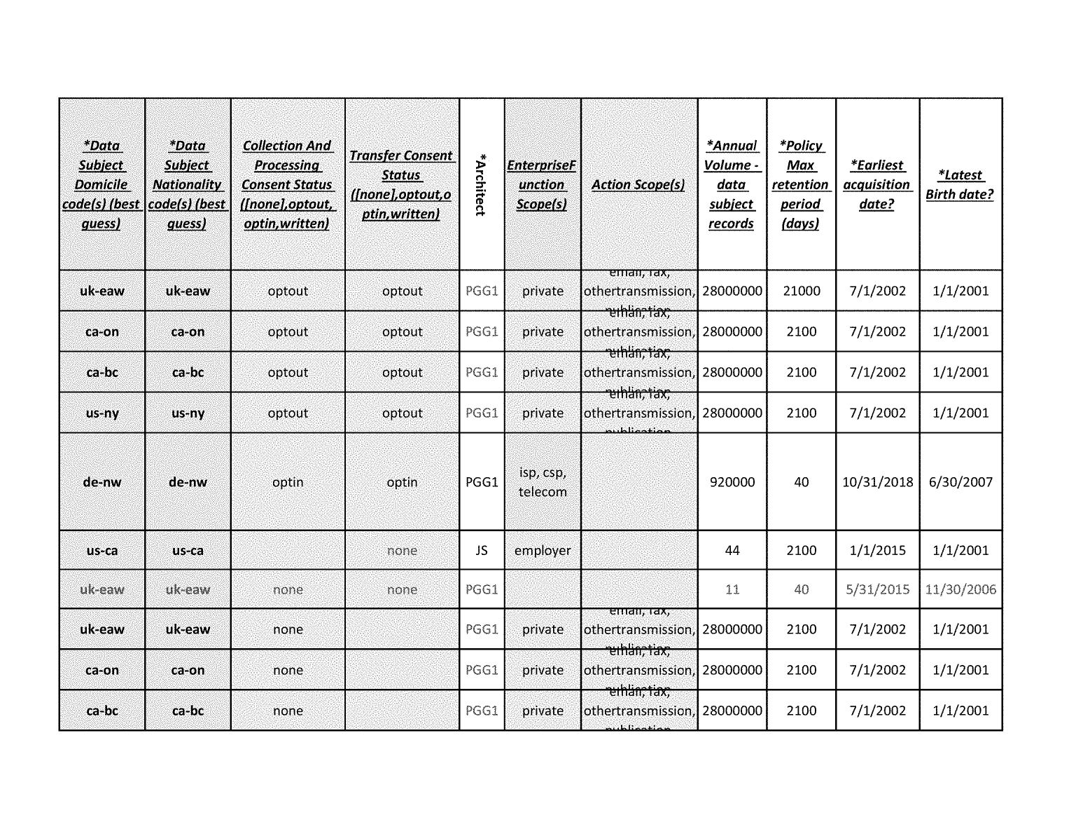

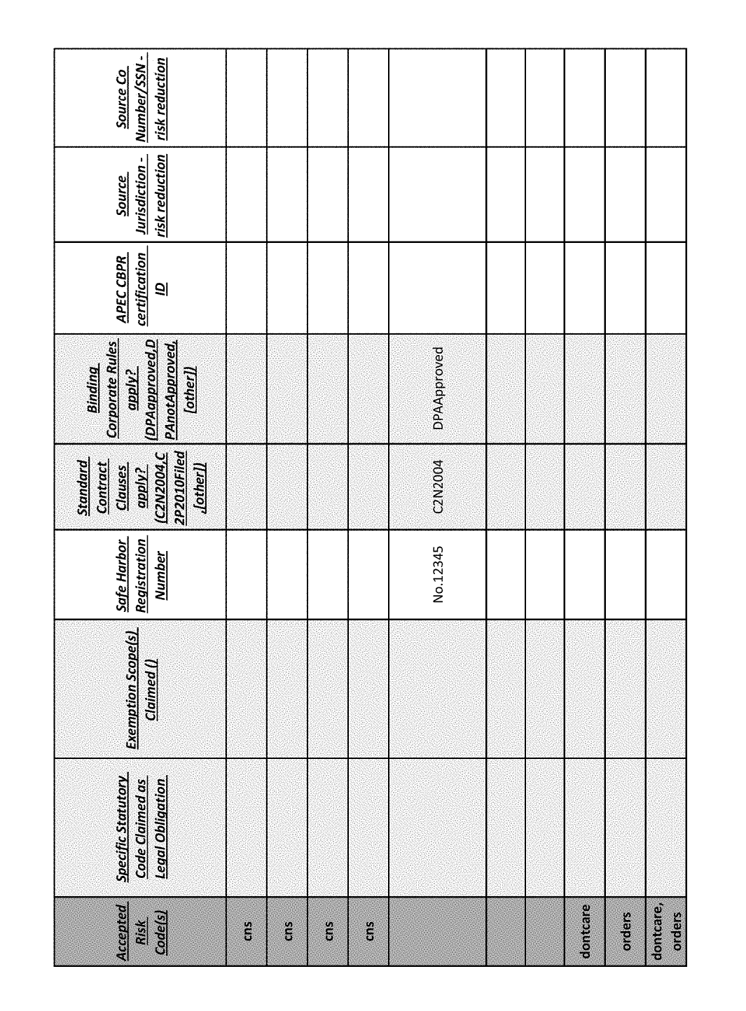

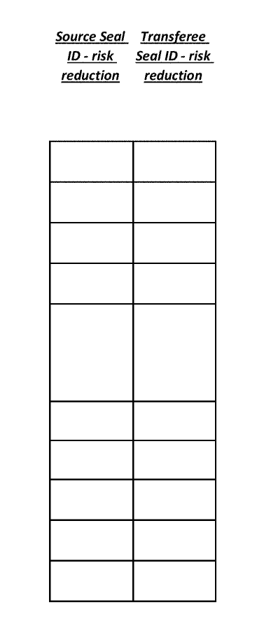

Referring now to FIG. 11, and continuing to refer to FIG. 1, an exemplary Privacy Architecture 108 is provided for information purposes. For example, and without limitation, a Privacy Architecture 108 may be captured as worksheets that may be created by the Metadata Editor Subsystem 104 (see Blocks 530, 535, and 540 at FIG. 5) and/or formatted to be input to the Risk Assessment Subsystem 105 (see Blocks 630 and 645 at FIG. 6) and processed to produce automated PIAs, to generate notification lists, to facilitate privacy-by-design transaction processing, etc. Therefore, for manual processing, and other manual purposes such as monitoring metrics, many columns may be regarded as either “gold-plating” or insufficient.

Privacy Architecture 108 worksheets also may be designed to advantageously communicate information to regulators, auditors, underwriters, actuaries, stockholders, the general public, IT architects, and others (see FIG. 3) by way of a “common language”. The following describes how to read the worksheet:

1. Each entry (line) in the spreadsheet may represent a privacy-oriented information-architecture specification for a single dataset-process combination. These for convenience may be called “data flows,” as defined above, even though some processing, such as profiling, may not necessarily involve any flow of data from one system/place to another.

2. Each column may have a heading describing its purpose.

3. Asterisks (*) preceding a column heading may indicate that the column is considered mandatory.

4. The first two columns may be ignored, as these may act as “data flow-specific instructions” to the software.

5. Many columns may have a “default” value if left empty, indicated by square brackets (“[ ]”) in the column heading.

6. Column backgrounds may be color-coded for user convenience:

a. Yellow background may indicate the two “unique joint key” columns: dataset and process. The combination of these must be unique.

b. White background may indicate there is no validation performed on column values.

c. All other backgrounds may indicate that a subset of values is acceptable (and may be validated by software). This is not necessarily small. For example, and without limitation, over 80 data scope codes and over 380 jurisdictions may be recognized by the software.
i. Pink may be the general case
ii. Blue may be specific to jurisdiction codes.
iii. Green may indicate that the subset is accepted-risk codes defined by the business.

The contents as shown in FIG. 11 are examples only, and are not limiting in any way.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments failing within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc are used to distinguish one element from another. Furthermore, the use of the terms a, an, etc. do not denote a limitation of quantify, but rather denote the presence of at least one of the referenced item.

Thus the scope of the invention should be determined by the appended claims and their legal equivalents, and not by the examples given.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

That which is claimed is:

1. A computer-implemented method for data privacy compliance code generation using a privacy impact assessment system, the method comprising:
receiving legal guidance;
receiving a legal metadata test associated with a jurisdiction of interest;
creating a legal architecture comprising the legal guidance and the legal receiving privacy guidance;
receiving a privacy metadata test comprising at least one privacy record type selected from the group consisting of process-level and transaction-level;
creating a privacy architecture comprising the privacy guidance and the privacy metadata test;
receiving a data flow identifier associated with the privacy metadata test;
retrieving the privacy metadata test from the privacy architecture upon detection of an association between the data flow identifier and the privacy metadata test;
determining a relevant jurisdiction from the privacy metadata test, wherein the relevant jurisdiction matches the jurisdiction of interest of the legal metadata test;
retrieving the legal metadata test associated with the jurisdiction of interest from the legal architecture;
determining an outstanding risk using the privacy metadata test and the legal metadata test; and
creating a privacy impact assessment report comprising the outstanding Risk.

2. The method according to claim 1 further comprising receiving a legal tuning to the legal metadata test, and recording the legal tuning to a legal audit trail.

3. The method according to claim 2 further comprising creating an anti-gaming notification using the legal audit trail.

4. The method according to claim 1 further comprising receiving a privacy tuning to the privacy metadata test, and recording the privacy tuning to a privacy audit trait.

5. The method according to claim 1 wherein the legal guidance is of at least one applicable law type selected from the group consisting of a statute rule, a tort rule, and a treaty rule.

6. The method according to claim 5 wherein the legal metadata test comprises at least one analytic associated with the at least one applicable law type.

7. The method according to claim 5 wherein the at least one applicable law type further comprises a first applicable law type and a second applicable law type that share a legal relationship, defined as a regime.

8. The method according to claim 1 further comprising receiving custom rule metadata, and creating the legal architecture to further comprise the custom rule metadata; wherein determining the outstanding risk further comprises using the custom rule metadata.

9. The method according to claim 8 further comprising recording the custom rule metadata to a legal audit trail.

10. The method according to claim 9 further comprising creating an anti-gaming notification using the legal audit trail.

11. The method according to claim 1 further comprising receiving accepted risk metadata; wherein determining the outstanding risk further comprises using the accepted risk metadata.

12. The method according to claim 1 further comprising:
receiving a target client identifier and at least one target application identifier associated with the data flow identifier;
creating an Application Programming interface (API) comprising the data flow identifier; and
deploying the API to a target client associated with the target client identifier.

13. The method according to claim 12 wherein the API further comprises at least one of a packaged risk assessment subsystem, a packaged report generator subsystem, a legal architecture instance associated with the legal architecture, and a privacy architecture instance associated with the privacy architecture.

14. The method according to claim 12 further comprising creating a software as a service (SaaS) interface comprising at least one of a risk assessment SaaS locator, a report generator SaaS locator, a legal architecture locator associated with the legal architecture, and a privacy architecture locator associated with the privacy architecture.

15. The method according to claim 1 further comprising determining semantic validity for at least one of the legal architecture and the privacy architecture.

16. The method according to claim 1 wherein creating the privacy impact assessment report further comprises tailoring the privacy impact assessment report to an audience type selected from the group consisting of a technical-consumer, a technical-provider, a legal-consumer, and a legal-provider.

17. The method according to claim 1 wherein receiving the privacy metadata lest further comprises prepopulating the privacy metadata lest from at least one of data dictionary metadata and enterprise profile metadata.

18. The method according to claim 1 wherein the privacy impact assessment report comprises a financial quantification of an expected cost of an actual data privacy breach associated with the outstanding risk.

19. The method according to claim 18 wherein creating the privacy-impact assessment report further comprises creating a notification list comprising the outstanding risk and the financial quantification.

20. The method according to claim 1 wherein the outstanding risk is of a false negative type.

21. The method according to claim 1 wherein the legal guidance, the legal metadata test, the privacy guidance, and the privacy metadata test are each characterized by a common language.

22. The method according to claim 21 further comprising parsing and executing as interpreted code the respective common language of the legal guidance and the legal metadata test.

23. The method according to claim 1 further comprising creating a privacy policy using the privacy architecture.

24. The method according to claim 1 further comprising hosting the privacy architecture on a target client.

25. The method according to claim 24 wherein hosting the privacy architecture on the target client further comprises:
embedding the privacy architecture into the target application.
receiving a transaction comprising a personally identifiable information (PII) record, wherein the PII record is associated with the privacy metadata test and wherein the at least one privacy record type of the privacy metadata test is transaction-level; and
rejecting the transaction based on the outstanding risk.

26. A privacy impact assessment system for data privacy compliance code generation, comprising:
a metadata editor subsystem accessible via a network and configured to:
receive legal guidance,
receive a legal metadata test associated with a jurisdiction of interest,
create a legal architecture comprising the legal guidance and the legal metadata test,
receive privacy guidance,
receive a privacy metadata test comprising at least one privacy record type selected from the group consisting of process-level and transaction-level, and
create a privacy architecture comprising the privacy guidance and the privacy metadata test;
a risk assessment subsystem accessible via a network and configured to:
receive a data flow identifier associated with the privacy metadata test,
retrieve the privacy metadata test from the privacy architecture upon detection of an association between the data low identifier and the privacy metadata test,
determine a relevant jurisdiction from the privacy metadata test, wherein the relevant jurisdiction matches the jurisdiction of interest of the legal metadata test,
retrieve the legal metadata test associated with the jurisdiction of interest from the legal architecture, and
determine an outstanding risk using the privacy metadata test and the legal metadata test; and
a report generation subsystem accessible via a network and configured to create a privacy impact assessment report comprising the outstanding risk.

27. The system according to claim 26 wherein the metadata editor subsystem is further configured to receive a legal tuning to the legal metadata test, and to record the legal tuning to a legal audit trail.

28. The system according to claim 26 wherein, the metadata editor subsystem is further configured to receive a privacy tuning to the privacy metadata test, and to record the privacy tuning to a privacy audit trail.

29. The system according to claim 28 wherein the report generation subsystem is further configured to create an anti-gaming notification using the privacy audit trail.

30. The system according to claim 26 wherein the legal guidance is of at least one applicable law type selected from the group consisting of a statute rule, a tort rule, and a treaty rule.

31. The system according to claim 30 wherein the legal metadata test comprises at least one analytic associated with the at least one applicable law type.

32. The system according to claim 30 wherein the at least one applicable law type further comprises a first applicable law type and a second applicable law type that share a legal relationship, defined as a regime.

33. The system according to claim 26 wherein the metadata editor subsystem is further configured to receive custom rule metadata, and to create the legal architecture to further comprise the custom rule metadata; wherein the risk assessment subsystem is further configured to determine the outstanding risk using the custom rule metadata.

34. The system according to claim 33 wherein the metadata editor subsystem is further configured to record the custom rule metadata to a legal audit trail trail.

35. The system according to claim 34 wherein the metadata editor subsystem is further configured to create an anti-gaming notification using the legal audit trail.

36. The system according to claim 28 wherein the metadata editor subsystem is further configured to receive accepted risk metadata; wherein the risk assessment subsystem is further configured to determine the outstanding risk using the accepted risk metadata.

37. The system according to claim 26 wherein the metadata editor subsystem is further configured to:
receive a target client identifier and at least target application identifier associated with the data flow identifier;
create an Application Programming Interface (API) comprising the data flow identifier, and
deploy the API to a target client associated with the target client identifier.

38. The system according to claim 37 wherein the API further comprises at least one of a packaged risk assessment subsystem, a packaged report generator subsystem, a legal architecture instance associated with the legal architecture, and a privacy architecture instance associated with the privacy architecture.

39. The system according to claim 37 wherein the metadata editor subsystem is further configured to create a software as a service (SaaS) interface comprising at least one of a risk assessment SaaS locator, a report generator SaaS locator, a legal architecture locator associated with the legal architecture, and a privacy architecture locator associated with the privacy architecture.

40. The system according to claim 26 wherein the metadata editor subsystem is further configured to determine semantic validity for at least one of the legal architecture and the privacy architecture.

41. The system according to claim 26 wherein the report generation subsystem is further configured to tailor the privacy impact assessment report to an audience type selected from the group consisting of a technical-consumer, a technical-provider, a legal-consumer, and a legal-provider.

42. The system according to claim 26 wherein the metadata editor subsystem is further configured to prepopulate the privacy metadata test from at least one of data dictionary default metadata and enterprise profile default metadata.

43. The system according to claim 26 wherein the privacy impact assessment report comprises a financial quantification of an expected cost of an actual data privacy breach associated with the outstanding risk.

44. The system according to claim 43 wherein the report generation subsystem is further configured to create a notification list comprising the outstanding risk and the financial quantification.

45. The system according to claim 26 wherein the outstanding risk is of a false negative type.

46. The system according to claim 26 wherein the legal guidance, the legal metadata test, the privacy guidance, and the privacy metadata test are each characterized by a common language.

47. The system according to claim 46 wherein the common language of the legal guidance and the legal metadata test is of a computer-executable expression type.

48. The system according to claim 26 wherein the report generation subsystem is further configured to create a privacy policy schedule using the privacy architecture.

49. The system according to claim 26 wherein the metadata editor subsystem is further configured to transmit the privacy architecture to a target client.
50. The system according to claim 49 wherein the metadata editor subsystem is further configured to embed the privacy architecture into the target application, to define an embedded privacy architecture; wherein the embedded privacy architecture is configured to:
receive a transaction comprising a personally identifiable information (PII) record, wherein the PII record is associated with the privacy metadata test and wherein the at least one privacy record type of the privacy metadata test is transaction-level, and
reject the transaction based on the outstanding risk.
